(19) United States
(12) Patent Application Publication
(10) Pub. No.: US 2004/0158473 A1
(43) Pub. Date: Aug. 12, 2004

(54) Method of optimizing alliance agreements

(76) Inventor: Farok Contractor, Booton Twp, NJ (US)

Correspondence Address: Daniel A Scola Jr, Hoffman & Baron, 6900 Jericho Turnpike, Syosset, NY, 11791, US

(21) Appl. No.: 10/250,395

(22) PCT Filed: Dec. 26, 2001
(86) PCT No.: PCT/US01/49568

(51) Int. Cl. G06F 17/60

(52) U.S. Cl. 705/1

(57) ABSTRACT

The present invention relates to a method of conducting alliance negotiations which includes the steps of providing a benefit/cost/and market revenue framework which enables one or more potential allies to calculate a target monetary value that may be captured by one or more of said potential allies over the life of a potential alliance; using negotiation variables comprising different compensation types as well as non-financial variables, to generate potential profit target scenarios; and evaluating one or more tradeoffs between various compensation types to serve as potential negotiation proposals to a potential ally.

### FIELD OF THE INVENTION

The present invention relates to a method of negotiating alliance agreements and more particularly relates to a method and system for optimizing such agreements.

### BACKGROUND OF RELATED TECHNOLOGIES

Structuring an alliance between two or more entities or companies is an important part of the current worldwide economic landscape. There are a variety of reasons for the establishment of an alliance agreement and numerous forms of cooperative activity, or linkages between the parties, as well as the sharing or transfer of various types of assets. For example, most alliances involve the transfer, or sharing of proprietary corporate knowledge, intellectual property or territorial rights assigned from one partner to another. In such cases, the alliance agreement ordinarily provides for specific payments to the partner supplying the needed knowledge or legal rights. The payment can take many forms, such as a lump sum fee (typically paid at the start of the agreement); royalties (typically indexed as a percentage of alliance sales); and/or dividends as return on an equity position (in cases where the knowledge-supplying partner has an equity position in the alliance corporation). Traditionally, distinct agreement types, such as lump sum payment technology transfer contracts, or license agreements, or equity joint ventures were common. More recently, combined agreements, where multiple payment types are simultaneously present, are becoming increasingly more prevalent. To complicate things further, there is frequently also trade in components or finished product between the allies, at negotiated transfer prices, it being understood that one or both allies will earn a profit markup on the supply or purchase. The complexity of balancing these various compensation types to meet the overall needs and strategy of the allies is a complicated task. Two main questions are then posed to the negotiators. (1) how to place an overall value on the package of knowledge, intangible (as well as tangible) assets and other resources being contributed by one or several alliance partners (2) how to best determine the tradeoffs between the various types of compensation which fit the targeted net present value of the alliance to be created. This is an issue tackled by alliance agreement negotiators not just as a finance matter, but also as a strategy issue. This is because the mix of compensation types determines the strategy of the two partners, and their tendencies for opportunism and shirking, and future behavior towards the other partner, in general.

Proprietary corporate knowledge is currently considered a key to the distinctiveness of a firm and to its competitiveness. A company builds a competitive edge by creating intellectual assets, and organizing collective, tacit knowledge routines within the company. Such knowledge is proprietary, often idiosyncratic, imperfectly imitable and “sticky” or imperfectly mobile to other firms.

Since a firm differentiates itself from competitors by its knowledge base and intangible assets, it may sometimes prefer to keep that knowledge proprietary, so as to appropriate the maximum returns from its innovations and management skills, by exploiting its advantage in fully owned investments. In today's global context, however, where the end applications of a technology may range beyond the firm's normal product or territorial domains, where the firm cannot efficiently internalize all production activities, and where certain markets are better assessed through local partners, it is sub-optimal for a company to rely on its own operations completely. Increasingly, therefore, companies rely on alliances to extend their product and territorial reach, augment the returns from their knowledge creation, and in some cases, to achieve the combinatorial efficiencies that cannot be achieved by operating alone.

There is no “market price” for knowledge and intangible assets as such, except in specific cases such as franchising which involves standardized, repeated knowledge and intangible asset transfers. In most cases there is only a case-by-case bipartite negotiation between the prospective allies, i.e., the knowledge supplier and the knowledge recipient

There is a host of financial and strategic reasons why a knowledge and asset-supplying (tangible or intangible assets) ally should be paid with multiple cash flow channels of compensation. There is a need for a system and method for determining the overall value of the transferred knowledge and assets, and the “best” alliance agreement terms, based on the strategic and financial needs or desires of the allies. There is a need for a framework for easily evaluating allies' negotiation positions and which further facilitates proposals or counter proposals during the negotiation process. There is also a need for a method for determining key negotiation variables, the complex tradeoffs between such variables and balancing contradictions between economic efficiencies (profit maximization) and other strategic considerations which themselves often point in non-congruent directions for negotiation behavior. There is also a need for a system and software components which serve to facilitate the methods of the present invention.

### SUMMARY OF THE INVENTION

In one aspect of the invention there is provided a system and process of meeting the aforementioned needs.

One aspect of the present invention provides a method of conducting alliance negotiations which includes providing a benefit(cost/and market revenue framework which enables one or more potential allies to calculate a target monetary value that may be captured by one or more of said potential allies over the life of a potential alliance. The method further includes using negotiation variables which include different compensation types as well as non-financial variables, to generate potential profit target scenarios, such as isoprofit curves, as a basis for negotiating. The method further provides for evaluating one or more tradeoffs between the various compensation types to serve as potential negotiation proposals to a potential ally. A further aspect of the invention includes generating bargaining ranges for each ally. Estimates are arrived at for the total-present value of compensation and costs that could accrue to each potential ally.

The isoprofit curves are based on at least two different compensation types. Curves may be generated for one or each potential ally. The method further provides for the mapping of at least one pair of negotiation variables and assessing the impact of the combination of these variables on the potential profit targets of each potential ally.

The method further provides for comparing negotiation variables of a potential ally against the profit scenarios generated and selecting one or more tradeoffs to serve as a potential proposal to an ally. Identification of a tradeoff zone of compensation beneficial to the allies is further included in the method of the present invention. The tradeoffs are non-linear and non-zero sum tradeoffs between the compensation types. The steps in the method of the present invention may be iterative until a final agreement is reached.

Negotiation variables include financial and non-financial variables. Examples of negotiation variables include equity shares, royalties, lumpsum fees, intra-ally transfer-price, mark-ups, duration of the alliance and various combinations thereof. Other negotiation variables may include an evaluation of the risks associated with potential failure to provide continued cooperation, potential failure to provide continued exchange of information or exchange of resources, increases in margins on trade, proper reporting or calculation of royalties; concerns regarding unfavorable political and commercial environments and combinations thereof.

The profit scenarios, i.e., isoprofit curves, may be generated by a computer program based on the targeted monetary value. The isoprofit curves for any two allies will be different.

The present invention further provides for a method for generating compensation structures in an alliance agreement which includes the steps of:

a. generating one or more net present value (iso-profit) curves of a potential alliance entity for one or more potential allies based on non-zero sum tradeoffs between at least two compensation types; and

b. identifying the vector for increasing net present value for a particular ally.

The method further includes identifying among the curves a zone of mutual compensation benefit to allies. The net present value curves (isoprofit) are based on a target monetary value of the potential alliance. The net present value is calculated using a framework which includes an assembly of compensation, cost and revenue criteria for a potential alliance entity which enables potential allies to reach a target monetary value.

In another aspect of the invention, there is provided a system for generating a compensation structure in an alliance agreement, which system includes:

a. a financial framework comprising an assembly of compensation, cost and revenue criteria from which a target monetary value of a potential alliance entity can be calculated over the life of the potential alliance; and

b. a software program capable of manipulating data in conjunction with said financial framework.

Manipulation of the data includes using different compensation types and non-financial

variables to generate potential profit target scenarios, such as isoprofit curves, for one or more allies. The isoprofit curves may be the same or different for each potential ally. Manipulation of the data further includes the steps of mapping at least one pair of negotiation variables and assessing the impact of the combination or combinations thereof on the potential profit targets of each potential ally. The manipulation may further include evaluating one or more tradeoffs between the various compensation types.

The assembly of compensation, cost and revenue criteria are selected from royalty, loan amortization, imported components and combinations thereof.

The financial framework may be incorporated into a software program which may be a stand alone or part of a more comprehensive financial program and may be accessible via a computer network such as an internet or intranet network.

The system and method of the present invention may be incorporated into or used in conjunction with spreadsheet software.

This method presents a general approach to conducting alliance negotiations. While based on capital budgeting, a novel approach that can be written into a computer software package, as well as algebraic derivations, reveals complex non-zero-sum negotiation positions. The technique is eminently usable by practitioners and is intended for a variety of practitioners involved in the negotiations, evaluating and structuring of alliance agreements. Each alliance agreement structure has profit implications, but also reveals many fundamental strategy, risk, regulatory issues. Each alliance contract structure also has important implications for the future behavior of the allies towards each other. As an analytical tool this technique should integrate a negotiating team consisting of finance, strategy, and behavioral specialists. After all, companies undertake alliances not merely for profit maximization, but also for other important strategic objectives.

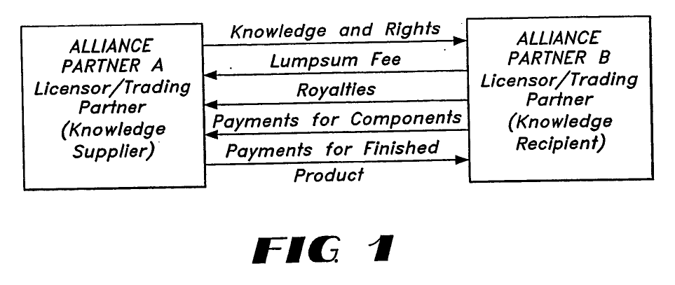

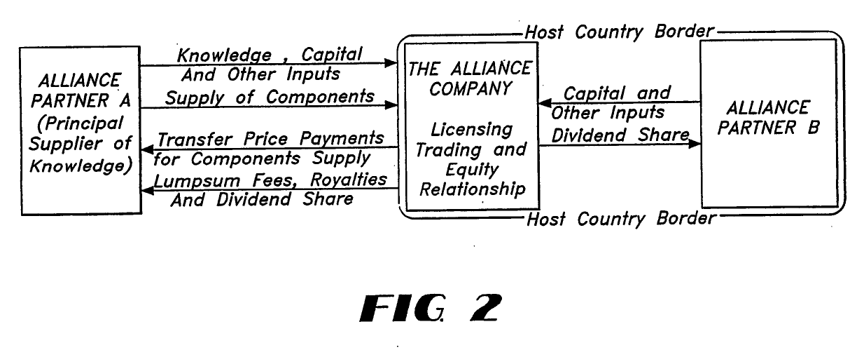

The essence of an alliance (defined here as any cooperative or joint action between two companies on a contractual and/or equity joint venture basis) is a transfer of knowledge and organizational capability. This transfer creates value in the recipient film. This method is concerned about how to structure the alliance agreement to compensate the knowledge-supplying partner and what each tradeoff between various compensation channels does for joint profit maximization, strategy and behavior. Alliances are increasingly being structured with multiple cash flows between the two allies in a contractual alliance (as shown in FIG. 1) or between the alliance firm and its principals (for the most general case illustrated in the schematic diagram of FIG. 2). The latter is typically a combination of an equity joint venture, which then also signs a license agreement with one of its investors who is the principal knowledge supplier to the alliance company. In addition, there frequently is trade between the alliance firm and one of its principals.

The method specifies several strategic advantages to having multiple cash flow channels. From the point of view of the partner that has supplied knowledge or expertise, or territorial rights to the alliance firm, lumpsum payments provide the surety of an immediate return. A royalty stream, being usually linked to sales, is less volatile than dividends. Royalties are earned even when profits of an equity joint venture have dried up in a cyclical down turn, and royalties have tax advantages over dividend remittances in both the nation of the alliance firm (being considered a deductible expense there) as well as in some royalty recipients' countries. An equity stake is, however, unquestionably superior in the event of commercial success in later years, and is more valuable than royalties constrained by the agreement formula to a fixed percentage. An equity stake is not subject to cancellation, whereas one of the alliance partners may not wish to renew a license on its expiry. Trade in raw materials or finished product, between the alliance firm and one of its partners, sets up a cash flow useful to the recipient (in similar ways to a royalty stream) in terms of lower volatility, transfer price markups earned, and the legal avoidance of alliance nation tax and currency convertibility problems.

Thus the strategic recommendation to negotiators is to set up multiple cash flow channels, in order to reduce cyclical volatility, reduce several types of risk, and taxes, and to cement ties between the corporate allies. Such multiple arrangements also increase the commitment of the partners and make the alliance more difficult to dissolve.

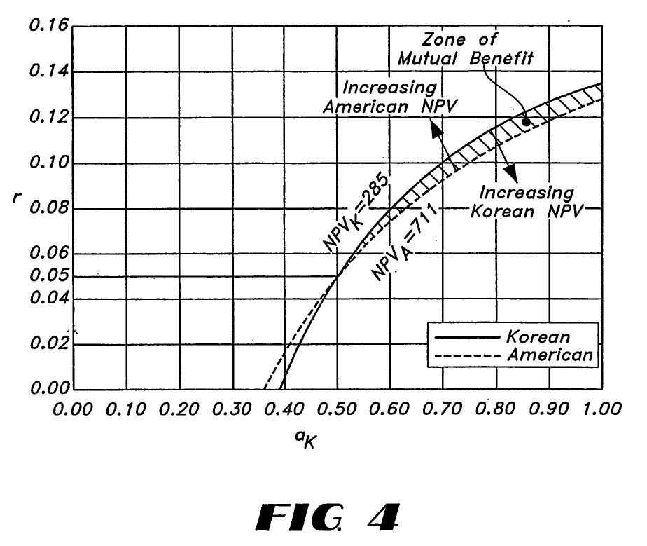

However multiple cash flow channels also increase the number of variables to negotiate over. Each partner targets a net present value (NPV), and then seeks a combination of at least the following variables: 1. Equity share “a”; 2. Lumpsum “L”; 3. Royalty Rate “r”; 4. Agreement life “y”; and 5. Intrafirm trade markup “m”, which will give it the target NPV. However, the present invention involves tradeoffs between the five variables which involve dynamic non-zero-sum games between the parties. By presenting algebraic expressions, as well as showing a simulation of a common alliance case, the present method maps these tradeoffs between the negotiation variables. Each map shows a representative of a family of isoNPV (profit) curves for each side, and the vector of its increase. Each map identified “Zones of Mutual Benefit,” where joint profits of both partners may increase. This can be more easily understood by reference to FIG. 4.

Movement to those zones can benefits both parties. However, that does not necessarily mean that they will always wish do so—for the financial benefit may be outweighed by strategic cautions and risk aversions. Moving to “zones of mutual benefit” may increase profit for one or both parties. But the negotiator must also assess the managerial control, risk, strategy and regulatory (tax, FDI equity and royalty limitations) considerations associated with each point on the variable maps. In many cases, the desire for financial profit maximization is tempered or reversed by these other concerns, summarized in Table 7 below.

This simulation technique is not intended only for finance practitioners, it is a vehicle to integrate a negotiating team consisting of finance, strategy, and behavioral specialists. The example used is an American alliance in Korea, but the approach can, of course, be applied to any two-party alliance. The simulation illustrates the complexity of negotiations. Behavior of alliance negotiations has been studied before to some extent but never in the context of behavioral implications of compensation alternatives.

For purposes of this invention, an alliance is described as any joint or cooperative activity involving two or more otherwise distinct companies. The alliance activity may occur under a medium to long term contract (including for example a license) and/or by forming a third joint venture company in which the principals each own an equity share. In some alliances there may additionally be components, product or services traded between the principals (or between one principal party and a separate joint venture company comprising the alliance).

For purpose of the present invention, the term “knowledge” will include proprietary information and expertise, such as technical, marketing, administrative, and other business information and-expertise; intellectual property such as registered and unregistered inventions, patents, trademarks and trade secrets; as well as tangible assets or other resources contributed by an ally to the alliance.

### DETAILED DESCRIPTION OF THE INVENTION

Hitherto, alliance negotiations have been “hit-or-miss” affairs as far as designing a compensation structure is concerned. Negotiators have, at best, hazy ideas about how much money their company should hope to earn from linking up with an alliance partner. The key aspect of most alliance agreements (here defined as any joint or cooperative activity between tow or more otherwise distinct firms) is the transfer between allies of proprietary corporate knowledge, intangible as well as tangible assets. Intangible assets include intellectual property such as brands, patents, copyrights, or “knowhow”, which is unregistered or sometimes even unwritten general corporate expertise. These are increasingly separable from their organizational context, and can be sold or shared with another firm—for compensation. As such activity increases—as part of a general trend towards outsourcing and modularization of business functions, aided by codification of previously tacit or intuitive knowledge—placing a money value on a “knowledge and assets package” is a crucial managerial function. The Benchmarks and criteria are presented for the first time, in a comprehensive valuation framework, eminently usable by managers and negotiators.

Determining the Target Monetary Value of an Alliance and a Framework for Determining Negotiating Ranges for Each Prospective Alliance Partner

This is best explained by a case study. Let us suppose Company A has developed a technology in the US at a cost of $ 8.6 million on research and development, codification, and general commercialization including legal and other fees for registering intellectual property A). Company A has made successful inroads into the US market, and has also begun to export the product to Country B. Direct exports to country B are expected to be reasonable, but fall short of country B's potential because Company A lacks good marketing presence in that country. Export Sales estimates over the next 10 years are shown in the second column of Table 1 below.

TABLE 1
Cash Flow Example for A Prospective Licensing Opportunity
Development, Codification and IP Protection Cost of Technology $8.6 million
Projected Cash Flows Relating to License Proposal ($ Millions)

| | Export | | Company | Company B's | | | Direct Transfer, |
|---|---|---|---|---|---|---|---|
| | Sales | Lost Margins | B's Sales | Incremental | Lumpsum Fee | Lumpsum Fee | Transaction |
| | Directly by | on Exports (at | of Licensed | Profit Margin | plus Royalty | plus Royalty | and Training |
| Year | Company A | 10%) | Item | (at 16%) | (at 4%) | (at 6%) | Costs |
| 1 | 0.5 | .05 | 0.5 | .080 | .10 + .020 | .10 + .030 | 0.12 |
| 2 | 0.6 | .06 | 1.2 | .192 | .048 | .072 | 0.05 |
| 3 | 0.8 | .08 | 1.8 | .288 | .072 | .108 | 0.01 |
| 4 | 0.8 | .08 | 2.5 | .400 | .100 | .150 | 0 |
| 5 | 1.0 | .10 | 4.0 | .640 | .160 | .240 | 0 |
| 6 | 1.1 | .11 | 4.5 | .720 | .180 | .270 | 0 |
| 7 | 1.1 | .11 | 4.6 | .736 | .184 | .276 | 0 |
| 8 | 0.9 | .09 | 5.0 | .800 | .200 | .300 | 0 |
| 9 | 0.5 | .05 | 5.0 | .800 | .200 | .300 | 0 |
| 10 | 0.2 | .02 | 5.0 | .800 | .200 | .300 | 0 |
| PVs | | PV at 12% = | | PV at 17% = | PV at 15% = | PV at 15% = | PV at 12% = |
| | | 0.42 | | 2.01 | 0.64 | 0.92 | 0.15 |
| Years | | | | | PV at 15% | PV at 15% | |
| 1 to 5 | | | | | assuming non- | assuming non- | |
| only | | | | | renewal = | renewal = | |
| | | | | | 0.33 | 0.44 | |

Note:
The lumpsum fee is a one time payment of $.10 million in Year 1.

To better exploit country B's market potential negotiations have begun with Company B in that nation, with the idea of making Company B a licensee. With their own complete presence in country B, and long experience, and links there, Company B can take the same technology and achieve considerably better sales over the 10 year product cycle, as shown in the fourth column of Table 1. By “technology” is meant an agreement-based package of rights, restraints and services that includes some patent and copyright permissions for the assigned territory, but more importantly, includes uncodified “knowhow” and training the prospective licensee so that they can produce an efficient product in their country.

It is important to note that the principles and framework described herein apply to any other alliance type including an equity joint venture, turkey or training contract, etc., as well as applying to companies in the same or different countries, or division of a single entity.

The present invention provides for the unique assembly and use of various benchmarks to provide a new framework Table 2, below, sets forth the overall framework from which bargaining ranges can be derived for each negotiating ally. Benchmarks are actual financial calculated amounts which are used to construct the bargaining ranges of the present invention.

Benchmarks for Valuation

Development Costs

Should Company A ask for $ 8.6 million from Company B to cover the development costs? This may be a justifiable position if the development was motivated by, and amortizable over, only market B—a situation which occasionally happens in contract research. In most cases however, R&D is motivated by the home, and a few other principal country markets of the developer. Company A spent $8.6 million mainly with the expectation of returns from its home in the US plus a few other major nations. Besides, in theory at least, Company A can establish its own subsidiary, export, or form an alliance in each of the 180 nations of the world, thereby recovering even more against its R&D expenditures for this technology. These days, development costs can be motivated by, and amortized over, the global market, or at least several nations.

But such costs are sunk, or irretrievable. What was spent in the past by Company A has no bearing on Company B's willingness, or ability to pay. Company B moreover knows that part of the $ 8.6 million has already been recovered by Company A from its success so far in the US market—and there are many more countries yet to exploit.

Of course, as a negotiation ploy, Company A's representatives may harp on their large development costs. R&D costs (Valuation Benchmark 1) may be considered sunk costs that usually have little bearing on the value of the developed intangible asset outside the market purview of the developer (except in the case of specific contract research).

Hence, Valuation Benchmark 1: R&D costs are costs that usually have little bearing on the value of the developed intangible asset outside the market purview of the developer (except in the case of specific contract research).

Transfer Costs

Let us now take the viewpoint of the prospective recipient of this knowledge to be licensed as an intangible asset/service package. The negotiations have proceeded sufficiently far that Company A has estimated the direct cost of the transaction in terms of its (a) incremental legal and negotiation costs (b) training or teaching costs over years 1, 2, and 3. These “Transfer costs”—to transfer the technology and capability to Company B—are shown in Table 1 in the last column. They total $ 0.18 million over three years, or have a $ 0.15 discounted present value.

Should Company B therefore argue that a payment of $ 0.15 to 0.18 million is adequate? No. The knowledge supplier, Company A is most unlikely to agree. The “Transfer Cost” figure is only the absolute minimum compensation needed to recoup only the direct incremental cost of the agreement incurred by Company A. On top of that, Company A may want a recovery of part of its R&D costs and some profit. To emphasize the point, consider whether a software developer would agree to sell a software package merely for the low marginal cost of transmitting it to a user?

Hence, Valuation Benchmark 2: the marginal cost of knowledge comprises a “floor price” or minimum value for the knowledge.

This is less trivial a proposition than it would appear. The transmission costs of a developed software package may be close to zero. However, in cases of very complex technology the marginal or transfer costs can be large, and sometimes larger then the compensation that can be thrown off from a small or poor nation to compensate the knowledge supplier.

Market Value

The most important valuation benchmark is the value of the transferred knowledge in its new market, or field of use. Company B (the recipient of the knowledge) is expected to achieve sales of the licensed product as shown in the fourth column on Table 1. At an expected 16 percent profit margin, Company B's profits shown in the fifth column, have a discounted PV (Present Value) of $ 2.01 million.

Should the knowledge developer Company A demand $ 2.01 million for transferring the knowledge/services package? That would leave company B neither better oft nor worse off, while all the gains of the knowledge transfer accrue to Company A. It is unlikely that Company B would agree to pay $ 2.01 million, unless own their sales and profit estimates greatly exceed those shown in Table 1. In general the profits thrown off as a result of a new knowledge transfer into a new market Valuation Benchmark 3a, comprise a “Ceiling Price” or maximum value payable to the knowledge supplier.

Hence, Benchmark 3a: profits thrown off as a result of a new knowledge transfer into a new market comprise a “Ceiling Price” or maximum value payable to the knowledge supplier. In the case of an existing product, where a knowledge transfer improves efficiency and reduces costs, we have Valuation Benchmark 3b, i.e., the marginal cost savings, resulting from the transfer of new knowledge to an existing market. This comprises a “Ceiling Price” or maximum value payable to the supplier.

In either case, the actually negotiated compensation will usually be considerably lower than the maximum, because of moderating variables discussed later. Company B, as licensee, will actually want to pay much less, so as to leave the lion's share of the market value created, to itself.

Opportunity Costs

Recall that the knowledge supplier, Company A, does have some prospects for directly exporting the product to market B. On these exports Company A expects to earn 10 percent margins shown in column three of Table 1, whose discounted Present Value totals 0.42 million. By setting up the licensee, Company A not only incurs Direct Transfer and Training Costs (of $ 0.15 million shown in the last column), but it will also lose the opportunity to export to country B and earn a profit margin totaling $0.42 million. (A licensee is often given exclusive rights to their national territory). Company A would consider itself foolish therefore, to agree to any compensation lower than a floor of (0.15+0.42)=$ 0.57 million.

Hence, Valuation Benchmark 4a: Profits on business lost to the knowledge developer, as a result of the knowledge transfer, comprise an addition to the floor price, or minimum compensation needed to justify the transfer.

A similar logic would apply in another common scenario. In oligopolistic situations like Korea, signing an alliance agreement with one conglomerate my spoil existing relations with another conglomerate, and diminish profits from trade with the latter. An estimate of lost business, and profits, from the existing conglomerate relationship would comprise an estimate of Company A's opportunity costs in Korea.

Consequential Costs

A variant on the opportunity cost logic is the idea of consequential costs. For instance, in alliances, there is the fear of misuse of intellectual property or technology “leakage” of two sorts. Leakage of technology to third parties, or competition from a former ally, or a licensee is a potential cost to be considered. This can occur after, but even before, the termination of an alliance agreement. Similarly, a brand misused by a marketing ally in another country, or poor service rendered by a franchisee, can hurt the reputation of the brand in third nations, or globally. This is not merely a strategy or negotiation abstraction. Money damages from such consequential costs are routinely calculated by courts worldwide. Here the negotiator may make such a calculation preemptively, assigning it some expected likelihood.

Hence, Valuation Benchmark 4b: Lost profits to the knowledge supplier, as a consequence of leakage, increased competition, and degradation of intellectual property value, comprise a possible addition to the floor price or minimum compensation needed to justify the transfer.

Industry “Norms”

For better or worse, there are industry “norms” referenced by courts and the tax authorities or IRS, as indexes of “reasonable” royalties in different product areas. This has arisen, in part from the IRS' search for arms-length equivalent benchmarks and the courts' desire to impose infringement penalties on violators that are based on industry averages.

One often-cited “norm” for calculating royalties is the so-called “25 percent criterion”. This states that the lion's share of the incremental profits created by the license, three-quarters, ought to go to the licensee—while the licensor should receive royalties totaling 25 percent of the incremental profit Why? It can be argued that this is because it is the licensee company (B in our case), that makes the capital investment, carries the heat of the marketing battle in their nation, and bears the investment risk. The licensor, it can be argued, is only the passive collector of royalties and fees, should the venture succeed, and their risks are limited to receiving no royalties in the even of failure.

Based on this “25 percent norm” Company B, as prospective licensee, proposes a lumpsum of $ 0.10 million plus 4% royalty rate, shown in the sixth column of Table 1. This produces a discounted Present Value (PV) of $ 0.64 million, which is in fact 32 percent of the $ 2.01 million incremental profits of Company B. This is more than the 25 percent norm, and Company B considers this a generous offer.

However, the fact remains that such “norms” have no economics basis, and merely reflect past tradition and industry averages. They have no theoretical merit. But because they are referenced by negotiators, courts and tax authorities, they act as benchmarks.

Hence, Valuation Benchmark 5: Negotiators' demands are often moderated by reference to “industry norms” such as sector averages and the “25 percent criterion.”

The Bargaining Range

But no economics theorist would make a normative recommendation that a knowledge developer should be content with only 25 percent of incremental profits. Even in practice, for a highly valuable technology, a knowledge developer could justifiably demand much more—even as passive collectors of royalty—and get the higher rates from licensees or JV partners eager to obtain the new item for their market. The entire bargaining range, from $ 0.57 (0.15 in Direct Transfer/Training Costs+0.42 in Opportunity Costs) as a floor price, to $2.01 million in incremental profits, as a ceiling, comprises the bargaining range. Company B has proposed a Lumpsum of $ 0.10 million plus 4% royalties, amounting to compensation of 0.64 million, not very much higher than the knowledge supplier's floor price of) 0.57 million.

Company A counter-proposes with a demand for Lumpsum of $ 0.10 million plus 6% royalties, which would produce a discounted present value of $ 0.92 million (second-last column in Table 1). From Company A's calculation, this would produce a net agreement profit of (0.92-0.57)=$ 0.35 million. Even this $ 0.35 million could be posed by Company A negotiators as not really profit, but merely a needed partial recovery of the past R&D costs of $ 8.6 million.

Options Moderating the Bargaining Range

As a general principle, the value of an intangible asset can range up to the marginal profits and/or cost savings created by its incremental use in a new market or new field of use. However, this maximum is typically not all to be appropriated by the knowledge supplier and their demands are often moderated downward by options available to the knowledge recipient.

In our case, Company B was in touch with Firm C in Sweden, which has a similar technology claimed to be roughly equivalent. Firm C is willing to license this at a 5% royalty. While preferring American technology from Company A, this alternative Swedish option nevertheless enables Company B's negotiators to put downward pressure on Company A's demands.

Thus, suppose that the US Company A reached a final agreement with Company B (not shown in Table 1), that entailed a 5% royalty payment, but a somewhat higher lumpsum amount of $ 0.12 million (which would cover Company A's year 1 Direct Transfer costs, as shown in Table 1). This compensation stream (Discounted at 15 percent) produces for Company A, a Discounted Present Value of $ 0.80 million. At this level, both parties are in a “win-win” position, since both companies stand to make significant net profits from the knowledge transfer: 0.80−0.57=$0.23 million for the knowledge supplier and 2.01−0.80=$ 1.21 million for the knowledge recipient.

A range of options are sometimes available to a knowledge acquirer. The present value cost of each can be estimated, and used as a negotiating lever against a prospective knowledge supplier.

Valuation Benchmark 6a: The compensation demand of a knowledge supplier can be moderated downward by comparing with other options that may be available to the knowledge acquirer, such as (a) Obtaining the expertise from another source (b) Developing the capability in-house with their own R&D and (c) Risking deliberate patent or copyright infringement

By the same token, the knowledge supplier's bargaining position can be affected by options they have.

Valuation Benchmark 6b: The knowledge supplier's compensation demands can be influenced upwards or downwards by options such as (a) Compensation available from alternative alliance/JV partners in the target market (b) the Discounted Present Value of entering the market themselves by establishing a subsidiary, or other means

Indirect Benefits and Costs

Sometimes indirect costs and benefits to the knowledge supplier can be significant and have substantial monetary value or consequence. Indirect benefits to the supplier may include

Valuation Benchmark 7a: (i) Profit margins on supply/purchase deals with the partner or their associates, engendered by the agreement (ii) Network externality or scale benefits in the case of software and franchising.

The above indirect benefits have been substantial to some firms, even more than the direct cash throw-off from the agreement itself. For example, suppose a Detroit automobile firm forms an alliance with a Turkish assembler of cars. Direct royalties on each vehicle are trivial—merely a few hundred dollars per car. The real money made by the Detroit company is to be in the margin on the supply of kits, sub-assemblies and parts to the Turkish ally. Such indirect effects are sometimes mistakenly ignored by negotiators in their calculations, because they accrue to other divisions of the company, or because their calculation is deemed to be difficult. This is not necessarily the case, as an estimate of likely trade generated by the agreement can be made, profits estimated thereon, and discounted present value calculated.

Similarly there could be indirect costs, possibly accruing to other parts of the company.

Valuation Benchmark 7b: Indirect costs to the knowledge supplier, such as liability claims made by foreign customers, poor quality control or customer service leading to diminution of brand, service marks or reputation, should be factored into their cost calculation, together with estimates of the probabilities of occurrence.

Direct Compensation Paid For Knowledge

Once the terms of the agreement are finalized, one can calculate the discounted present value of direct payments to be made for the knowledge.

Valuation Benchmark 8: Direct payments for knowledge made in the form of contractually-specified fees and royalties (two examples are shown in columns six and seven of Table 1) and returns on equity investment in case the knowledge supplier takes an equity position in the recipient firm.

Duration of the Agreement

The desired duration of an alliance agreement is another area where negotiators are uncertain and take hit-or-miss approaches. The overall negotiating framework described below in Table 2 gives needed guidance. For instance, in the hypothetical case described above, the last row of Table 1 shows the present value of compensation if cash flows stopped after Year 5. Such a calculation clearly shows that a short agreement would yield insufficient return to the knowledge supplier, even with a high royalty. Prospective licensees stoutly maintain that they will renew for another 5 year term. But can they be trusted? If not, alternatives such as a joint venture (of theoretically indefinite life) or acquisition, or “greenfield” entry in to the market by the knowledge (and intangible or tangible asset) supplier, should be considered.

It is understood that alliances do not always involve only one partner giving knowledge and (intangible or tangible) assets to the other partner that pays compensation in return. Often, the resource flows are bi-directional. However, for expositional simplicity, the discussion here has been as if the flow was uni-directional. Knowledge and asset flows may be bi-directional.

A Comprehensive Framework for the Valuation of Transferred Knowledge

We can now summarize the above Valuation Benchmarks into a comprehensive framework. The whole objective is to reduce each valuation concept to a measured monetary figure—in short, to put a discounted present value number to several valuation benchmarks, and then provide an overall bargaining framework, shown in Table 2.

B8 is shown in two versions in Table 2. B8b is (the present value of) direct compensation paid by the ally who is the knowledge and (intangible or tangible) asset recipient. However, because of possible withholding and other cross-border taxes, the (present value of) the amount received by the knowledge and (intangible or tangible) asset supplier is less, B8a. B8b>B8a.

TABLE 2
AN OVERALL ALLIANCE VALUATION AND BARGAINING FRAMEWORK

| | Calculate Discounted Present Value of | |
|---|---|---|
| | BENEFITS | COSTS |
| KNOWLEDGE (and | B8a: Direct Compensation Received as part of | B1: R&D costs |
| Asset) SUPPLIER | knowledge transfer or agreement | B2: Marginal cost of knowledge transfer |
| | B7a: Indirect benefits | B4a: Opportunity costs (Profits on business lost |
| | | as a result of the knowledge transfer) |
| | | B4b: Consequential costs |
| | | B7b: Indirect Costs |
| KNOWLEDGE (and | B3a: Incremental Profits from use of knowledge in | B8b: Direct compensation paid for knowledge |
| Asset) RECIPIENT | new market | acquisition |
| | B3b Efficiency/Cost Savings on existing items from | |
| | use of new knowledge | |

| | |
|---|---|
| MODERATING | B5: industry “norms” |
| FACTORS FROM | B6a: Other acquisition options available to the knowledge acquirer |
| THE EXTERNAL | B6b: Alternative market entry options available to |
| ENVIRONMENT | knowledge supplier |

Criteria For Negotiating

Each negotiating side should calculate all the relevant benchmarks for benefits and costs shown above. From this follows axiomatic conclusions:

B8b<<B3a+B3b. 1)

From the knowledge (and intangible or tangible asset) recipient's perspective the direct payments they make to acquire knowledge should be much less than the incremental benefits created by the transfer of this knowledge to their territory or field of use.

(B8a+B7a)−(B2+B4(a+b)+B7b)>>0 2)

From the knowledge (and intangible or tangible asset) supplier's perspective the direct plus indirect benefits of the transfer minus all relevant costs should greatly exceed zero. Otherwise, this proposed agreement is not worth it Notice that in the above expression, R&D costs B1 have been ignored, on the grounds that they are sunk costs. However, this may not be appropriate in case of contract research, or when the number of nations/markets/fields of use over which the R&D is to be amortized is small. In general, a better approach for a knowledge supplier would be to target,

(B8a+B7a)>(B2+B4(a+b)+B7b)+B1(pᵢ/p_{g})

where pᵢ is the expected sales in the assigned territory (or field of use) and p_{g} is the expected global sales for the world as a whole. The factor pᵢ/p_{g} then prorates the amortization of the R&D cost in proportion to the share of each market in the global total. These days, fewer companies are comfortable with treating R&D as a sunk cost, on the assumption that amortization need occur only over the home market or principal markets of the developer. With escalating R&D costs, companies are increasingly seeking returns from every foreign market Having said that, they and the other negotiating side know that under severe negotiating pressure, the R&D component can indeed be ignored. The compensation could still be incrementally acceptable.

3) (B2+B4(a+b)+B7b) comprises the “floor price” or absolute minimum for the knowledge. (claims 4 and 5)

4) (B3a+B3b) constitutes the “ceiling price” or absolute maximum.

5) (B2+B4(a+b)+B7b)<B8a<B8b<(B3a+B3b).

That is to say, the actual compensation finally agreed upon will fall between the bargaining range between the floor and ceiling. There is no deterministic model which specifies where B8 will fall within the bargaining range. We do know however that the final size of B8 will be influenced by

6) B5 or B6a or B6b, as moderating factors from the external environment

Selection of the Different Compensation Types in Alliances and Evaluating the Tradeoffs Between Them

Alliances are an indispensable part of today's management landscape, and negotiators must know how to structure them. These days, many alliance agreements include a multiplicity of payment types, including royalties, lumpsum payments, transfer-pricing markups and returns on equity (in case there is an equity joint venture). The following discussion presents these key negotiation variables, together with non-zero-sum tradeoffs between them. Each map of variable pairs indicates a “zone of mutual benefit” where the joint profits of both prospective alliance partners can increase. The mix of compensation types also determines the strategies of the two partners, and their tendencies for opportunism and shirking, and future behavior towards the other partner, in general.

Many alliances are not just contractual (e.g. arms-length licenses, franchises, management service agreements) or just equity-based (i.e. a pure equity joint venture company). A great many alliances, these days, exhibit a hybrid or multiple payment structure (Shane, 1996), with a mix of some equity participation by both partner firms, and/or a contractual knowledge transfer from one partner (or both) to the alliance company. The alliance firm signs a licensing agreement with one or both principals, and may pay a lumpsum at the inception, and running royalties thereafter, some interfirm trade between the alliance firm and one of the principals.

Twenty-five years ago, the modal choice literature treated exports, licensing and Foreign Direct Investment as alternative and distinct modes. By contrast many of today's alliances simultaneously include all three types into one interorganizational relationship.

The Advantages of Multiple Cash Flow Channels

Consider two companies that propose an alliance. (The same approach could be used with more than one partner). This could be a contractual or licensing type alliance, where the knowledge-supplying firm (licensor) supplies expertise and intellectual property rights to a knowledge recipient (licensee) for payment of a lumpsum fee and royalties. Licensor and licensee may also trade components and finished product with each other and earn additional profits. This is shown in the schematic diagram in FIG. 1.

The more general case however, is an alliance that-combines licensing with the creation of a third joint venture company, and also has a trading relationship with the latter, as illustrated in the schematic diagram of FIG. 2 below. This is the most general case, involving all four types of cash returns to the knowledge-supplying alliance partner: lumpsum, royalties, dividends and traded goods markups. However, fewer cash flow channels are, of course, also possible. In the general case, during the negotiations stage, the joint venture alliance firm does not yet exist. However the negotiating principals (Partners A and B) consider how the joint venture firm's cash flows will be affected by the agreement reached.

Creating multiple cash flow channels between the partners in a contractual alliance, or between the alliance joint venture firm and its principals is advantageous, as summarized in Table 3. While each type also has inherent drawbacks, a mix of cash flows, some paid up-front, some linked to sales and others to profits, reduces overall volatility, risk and tax, and has important strategic value to one or both partners. When negotiating an alliance agreement, each party is thinking of its own expected returns, but also about how the structure of the alliance will impact the behavior of the other partner after it is formed, and the longevity of the arrangement. Let us examine the implications (positive and negative) of each alliance payment type.

Lumpsum Payments

Lumpsum payments are often part of the prospective licensee or joint venture alliance firm's capital structure and are often financed out of long term debt. They provide an immediate, and certain, return to the partner that provides the alliance with expertise. (However, too large a lumpsum increases the capital cost to the paying firm, as well as its risks. These risks include paying too much for the expertise (bounded rationality), creating too high a debt service fixed cost, and the danger of subsequent shirking on the part of the knowledge-supplying partner which supplied the expertise. The negotiation dynamics of these issues will be discussed in more detail later.

TABLE 3
Strategic Advantages of Multiple Cash Flow Types

| | | Margins on Components or |
|---|---|---|
| | | Product Traded with Affiliate |
| Lumpsum Fees and Royalties | Dividends/Equity Share | or Licensee |
| Lumpsum fee provides | Direct share in future | Margins can be high on |
| immediate cash return | success, growth and | proprietary, high-tech, or |
| Royalties are inherently less | profits of affiliate | branded items |
| volatile compared to dividends | More valuable as years | Less affected by cyclical |
| paid out of uncertain profits | pass than fixed percentage | fluctuations compared to |
| Royalties earned even if | royalties | dividends |
| affiliate/licensee's profits are | No expiration (By | Profit margins earned outside |
| zero | comparison, a licensing or | affiliate/licensee country |
| Licensing income legally | materiel supply agreement | jurisdiction, i.e., no |
| escapes the local tax in the | may terminate) | convertability risk |
| payer's nation | | Transfer pricing advantages |
| Also possible lower tax to the | | |
| licensor (compared to | | |
| dividends) | | |
| All royalties kept by licensor | | |
| (dividends have to be shared | | |
| with an equity joint venture | | |
| partner) | | |

Royalty Payments

Royalties (paid by licensee to licensor in a contractual alliance, or in the general case, paid by the alliance firm to one of its principals as licensor) are typically a percentage of sales. Royalties are therefore a variable cost, easily paid by the alliance firm out of, and contingent on, sales success. From the viewpoint of the knowledge supplier, as recipient of the cash flow, they are moreover axiomatically less volatile over the business cycle, compared to (joint venture) dividends, which are distributed out of far more volatile profits. The reason for this is because sales on which royalties are based are inherently more steady over the business cycle, compared to profits from which dividends may be distributed. In a recession, royalties are earned even if the alliance company's profits are zero. Moreover, royalties are contractually specified. Dividends, by contrast, require a joint decision each year. Thus royalties are inherently less risky a return than dividends. An alliance partner which is a net knowledge recipient, may also prefer royalties paid over many years, over lumpsums, since the former ensure continued future assistance from the partner firm acting as licensor. Moreover, in virtually every nation, royalties are treatable as a deductible expense to the alliance firm. This means that the remittance of royalties across borders, legally escapes the corporate income tax of the nation. (Dividends, by comparison, have to be paid only after the local tax bite). The receipt of royalties may also attract more favorable tax treatment in the licensor or knowledge supplying firm's home country if that nation's tax authorities treat the remittance as a return on past R&D. Finally, whereas dividends are shared by the partners in a pure equity joint venture, royalty payments do not have to be shared. All of the royalties accrue to the knowledge-supplying alliance partner, acting as licensor. For these reasons, these days a royalty-based payment is increasingly combined with an equity joint venture in a general-case alliance relationship as shown in the schematic diagram in FIG. 2.

Return from Equity Joint Venture Stake

On the other hand, as Table 3 shows, an equity stake in an alliance is often the most valuable, especially in later years, should the alliance venture succeed. In theory at least, an equity stake has no expiration, unlike a licensing-type agreement which has a fixed duration—which may or may not be renewed by the other partner on expiry. If they do not perceive any continuing knowledge transfer on termination of a technology transfer agreement, the licensee (in a contractual or license alliance) or one of the joint venture partners (in the general case) may refuse to renew the agreement. After all, ceteris paribus, continuing royalty payments by the technology receiving firm reduces the distributable profit (for the licensee, or for both shareholders in the general case). The partner which is a net knowledge recipient may sometimes prefer a pure equity joint venture investment by the knowledge-supplier. But the knowledge-supplying partner often prefers a hybrid arrangement involving multiple cash flows, to benefit from the advantages of each type.

An equity stake also naturally sidesteps several not fully-resolvable problems inherent in merely arms-length contracts. These include: (a) Not being able to write a “complete contract” which foresees all contingencies. This is because equity shares are the simplest profit-sharing device where profit and risk sharing substitutes for convoluted contractual specifications; (b) Information asymmetries between prospective allies in an equity joint venture both partners know they will be in the same bed together through thick and thin, or (c) Fears resulting from weak intellectual property rights. This is not to assert that equity joint venture stakes will fully resolve the above contract problems—only that bounded rationality, information asymmetry, and intellectual property right issues are better handled in the long run by an equity-sharing, as opposed to a purely contractual arrangement. Thus the inclusion of equity stakes by both partners acts as a natural risk, cost and profit sharing device, and sometimes enables an alliance to form, where otherwise negotiations would be fruitless.

Mark-Ups on Items Traded Between the Alliance and One of Its Principals

It is often beneficial to include a raw material, component, or finished product trade. This applies to both types of arrangements shown in the schematic diagram of FIG. 1 for a contractual alliance, and for the general equity-based case shown in the schematic diagram of FIG. 2. While this also creates the potential for transfer-price disagreements, this disadvantage may be offset by the several advantages summarized in Table 3. Margins can be large, on proprietary, high technology, and branded items. Since components and raw materials are more or less linearly linked to output, margins on such supplies are also axiomatically less volatile over the business cycle, compared to dividends. Finally, since such margins can be earned outside the jurisdiction of the country in which the alliance is located, local tax and convertibility issues are avoidable in the first place. Seeing such benefits flowing to the foreign partner, a local alliance partner often reluctantly acquiesces to such an arrangement—especially if (i) there is no practical alternate source for the material or component, and (ii) in return, the local partner can ask for concessions on some other negotiation variable.

In brief, more and more alliances are being structured so as to create these multiple cash flow channels specified in the combined alliance agreement. Multiple payment channels reduce the overall volatility of total cash flow for at least one of the partners, reduce convertibility and other risks, can legally reduce taxes (to the extent that royalties and unit transfer prices are reasonable), and being less easily reversible, cement ties between the partners in the alliance. Multiple, or hybrid, arrangements are therefore very desirable, and are increasingly used.

Negotiation Complexity in Multiple Cash Flow Arrangements: Non-Zero-Sum Games

However, creating multiple payment provisions in an agreement also greatly increases the level of negotiation complexity in forming the alliance. What, for instance is the tradeoff between “x” percent royalty and a “y” percent equity stake? How for instance, might the transfer-price markup, agreed upon between the partners, be weighed against the royalty percentage payable to one of them. Alliance negotiations are often mixed motive games in which the partners simultaneously have convergent and divergent. A revenue stream such as royalties or transfer-price markups, earned by one of the principals acting as licensor or component supplier, is also going to be a cost to the other, or to the joint venture company in which both parties have a stake.

The transfer of knowledge and corporate capability, from one or both of the principals to the alliance organization, creates incremental value in the alliance country or market. The alliance will utilize this capability to generate revenues and earnings, which are to be divided and distributed back to the partners by a formula determined by the agreement. Experienced negotiators such as Lee or Matsunaga first make capital budgeting cash flow projections for the licensee's market or, in the general case, for the joint venture alliance firm. They then try to devise agreement formulae to define how the costs, revenues and profits of the alliance are to be shared by the principals, so that the knowledge-supplying firm, as licensor and/or equity partner, targets a certain Net Present Value (NPV).

The purpose of the following discussion is to show the non-zero-sum tradeoffs between the different compensation types and how these tradeoffs affect the profits of each partner. The second objective is to show how each mix of arrangements, or tradeoff negotiation, affects the future strategy, risk and subsequent behavioral incentives for each partner.

Negotiation Variables: An Example

A general alliance case (licensing cum equity investment cum trade), in terms of the tradeoffs between two variables at a time, is shown by a capital budgeting simulation based on a spreadsheet.

To illustrate the general alliance case, let us say a joint venture-cum-license company is to be formed in Korea, with share a_{A} held by an American partner, and share a_{K} held by the Korean partner. (a_{A}+a_{K})=1. (This negotiation technique can apply to an alliance between any two allies from the same or different nations). In return for American technology and training, the alliance firm will pay the American partner a lumpsum L and running royalties r, based on projected yearly sales S of the alliance. The alliance firm in Korea will also depend on import of components from the American partner, whose annual costs for these materials is M, but they will sell the materials to the alliance company at (1+m)M, where m is the transfer-price markup earned by the American partner. The initial capital investment amount is V financed by the equity, as shown in Table 4. The alliance company will finance the lumpsum payment by borrowing the amount L, as part of the long-term loan, from local banks at interest rate i_{K}. Other fixed costs amount to E annually. All the financing arrangements, as well as the alliance agreement, are expected to last for “y” years, at the end of which the alliance will be terminated (at zero residual value for simplicity). The corporate tax rate in the US is t_{A}, and that in Korea t_{K}. Like in most nations, the cross-border remittance of royalties escapes Korean tax, but all income received by the American partner is assumed to be subject to US taxes. The discount rates for the two partners are d_{A} and d_{K} respectively.

Projected cash flows and NPV calculations for both partners are indicated algebraically in Table 4. In practice, they would be replaced by numbers in a spreadsheet Table 5 shows the total variable set, and indicates the theoretical or “inherent” constraint for each, as well as the numerical baseline (or beginning) values used in the simulation.

TABLE 4
Projected Cash Flow In American (A) − Korean (K) Alliance

| | ALLIANCE FIRM (AF)> | | |
|---|---|---|---|
| 1 | SALES | S | |
| 2 | COSTS | | |
| 3 | Royalty | RS | |
| 4 | Loan Amortization | $( \frac{1}{y} + {i}_{x} ) L$ | |
| 5 | Imported Components | (1 + m)M | |
| 6 | OtherCosts | E | |
| 7 | TOTAL COSTS (3 + 4 + 5 + 6) | $rS + ( \frac{1}{y} + {i}_{x} ) L + ( 1 + m ) M + E$ | |
| 8 | Profit Before Tax (1-7) | $( 1 - r ) S - ( \frac{1}{y} + {i}_{x} ) L - ( 1 + m ) M - E$ | |
| 9 | Tax (8 × t_{K}) | ${t}_{x} \{ ( 1 - r ) S - ( \frac{1}{y} + {i}_{x} ) L - ( 1 + m ) M - E \}$ | |
| 10 | AF PROFIT AFTER TAX (8-9) | $( 1 - {t}_{x} ) \{ ( 1 - r ) S - ( \frac{1}{y} + {i}_{x} ) L - ( 1 + m ) M - E \}$ | |
| | <KOREAN FIRM STAKE IN AF> | | |
| 11 | Dividend from AF (10 × a_{K}) | ${a}_{x} ( 1 - {t}_{x} ) \{ ( 1 - r ) S - ( \frac{1}{y} + {i}_{x} ) L - ( 1 + m ) M - E \}$ | |
| 12 | Initial Investment | a_{K}V | <year 1> |
| 13 | NET CASH FLOW (11-12) | ${a}_{x} ( 1 - {t}_{x} ) \{ ( 1 - r ) S - ( \frac{1}{y} + {i}_{x} ) L - ( 1 + m ) M - E \} - {a}_{K} V$ | |
| 14 | Discount Rate | d_{K} | |
| 15 | KOREAN FIRM NPV <in year p> | $\frac{1}{{( 1 + {d}_{K} )}^{p}} [ - {a}_{K} V + {a}_{K} ( 1 - {t}_{K} ) \{ ( 1 - r ) S - ( \frac{1}{y} + {i}_{K} ) L - ( 1 + m ) M - E \} ]$ | |
| | <U.S. FIRM STAKE IN AF> | | |
| 16 | PROFIT | | |
| 17 | After Tax Lumpsum Receipt | (1 − t_{A})L | <year 1> |
| 18 | After Tax Royalty | r(1 − t_{A})S | |
| 19 | After Tax Component Profit | m(1 − t_{A})M | |
| 20 | Dividend from AF (10 × a_{A}) | ${a}_{A} ( 1 - {t}_{x} ) \{ ( 1 - r ) S - ( \frac{1}{y} + {i}_{x} ) L - ( 1 + m ) M - E \}$ | |
| 21 | TOTAL PROFIT (17 + 18 + 19 + 20) | $\begin{matrix}( 1 - {t}_{A} ) L + r ( 1 - {t}_{A} ) S + m ( 1 - {t}_{A} ) M + \\ {a}_{A} ( 1 - {t}_{x} ) \{ ( 1 - r ) S - ( \frac{1}{y} + {i}_{x} ) L - ( 1 + m ) M - E \}\end{matrix}$ | |
| 22 | Initial Investment | a_{A}V | <year 1> |
| 23 | NET CASH FLOW (21-22) | $\begin{matrix}( 1 - {t}_{A} ) L + r ( 1 - {t}_{A} ) S + m ( 1 - {t}_{A} ) M + \\ {a}_{A} ( 1 - {t}_{K} ) \{ ( 1 - r ) S - ( \frac{1}{y} + {i}_{K} ) L - ( 1 + m ) M - E \} - {a}_{A} V\end{matrix}$ | |
| 24 | Discount Rate | d_{A} | |
| 25 | US. FIRM NPV <in year p> | $\begin{matrix}\frac{1}{{( 1 + {d}_{A} )}^{p}} [ - {a}_{A} V + ( 1 - {t}_{A} ) L + r ( 1 - {t}_{A} ) S + m ( 1 - {t}_{A} ) M + \\ {a}_{A} ( 1 - {t}_{K} ) \{ ( 1 - r ) S - ( \frac{1}{y} + {i}_{K} ) L - ( 1 + m ) M - E ) ]\end{matrix}$ | |

*The same general principles apply to any alliance be it international or within one nation

TABLE 5
Variables And Their Ranges

| | | ‘Inherent’ | ‘Practical’ | Baseline |
|---|---|---|---|---|
| | Variables | Constraint | Constraint | Values |
| 1 | a_{K}, a_{A} | 0 ≦ a_{K}, a_{A} ≦ 1, | | 0.50; 0.50 |
| | | a_{K} + a_{A} = 1 | | |
| 2 | r | 0 ≦ r ≦ 1 | 0 ≦ r ≦ 0.10 | 0.05 |
| 3 | m | 0 ≦ m ≦ 1 | 0 ≦ m ≦ 0.25 | 0.10 |
| 4 | i_{K} | 0 ≦ i_{K} ≦ 1 | 0 ≦ i_{K} ≦ 0.25 | 0.15 |
| 5 | t_{K} | 0 ≦ t_{K} ≦ 1 | 0 ≦ t_{K} ≦ 0.50 | 0.40 |
| 6 | t_{A} | 0 ≦ t_{A} ≦ 1 | 0 ≦ t_{A} ≦ 0.50 | 0.30 |
| 7 | d_{K} | 0 ≦ d_{K} ≦ 1 | 0 ≦ d_{K} ≦ 0.25 | 0.12 |
| 8 | d_{A} | 0 ≦ d_{A} ≦ 1 | 0 ≦ d_{A} ≦ 0.25 | 0.10 |
| 9 | y | 0 ≦ y | 0 ≦ y ≦ 25 | 10 |
| 10 | S | 0 ≦ S | 0 ≦ M + E ≦ S* | 1000 |
| 11 | M | 0 ≦ M | 0 ≦ M ≦ S | 100 |
| 12 | E | 0 ≦ E | 0 ≦ E ≦ S* | 490 |
| 13 | V | 0 ≦ V | | 500 |
| 14 | L | 0 ≦ L | | 100 |

Note:
*At least in the negotiation stage, this should be true although it may be not when the joint venture is in operation.

It is worth emphasizing that the above assumptions shown in Table 5 represent a very common situation in alliances. The conclusions of the analysis are therefore fairly typical, and have general applicability. Moreover, the fundamental shapes of the tradeoff curves (and the deductions therefrom) in the figures discussed herein, will not change much even if we alter the baseline simulation values. The general negotiations approach is a robust one.

IV Tradeoffs Between Negotiation Variables: Implications for Control, Strategy, Risk and Behavior

Out of the total set of variables indicated in Table 5, the most critical variables, which negotiators are concerned about, are shown in Table 6. In order to illustrate some of the tradeoffs, a simulation was performed, and isoprofit (isoNPV) curves generated for each of the negotiating parties. Experienced alliance negotiators as well as academics recommend first targeting NPV, and then assessing tradeoffs among the negotiation variables.

TABLE 6
Negotiation Variables
Baseline Simulation Scenario

| | |
|---|---|
| 1. Equity Shares: a_{A}/a_{K} | .50/.50 |
| 2. Royalty Rate: r | .05 |
| 3. Lumpsum: L | $200 (thousand) |
| 4. Markup on Interfirm Trade: m | .10 |
| 5. Duration of Alliance Agreement: y | 10 years |

(This is not to suggest that profit maximization is the sole objective for entering into an international alliance. Other important motives may include acquisition of technology, market penetration, assured supply, etc. But this method is focused on the negotiation, strategy, risk, and behavioral implications of the tradeoffs between the cashflow types).

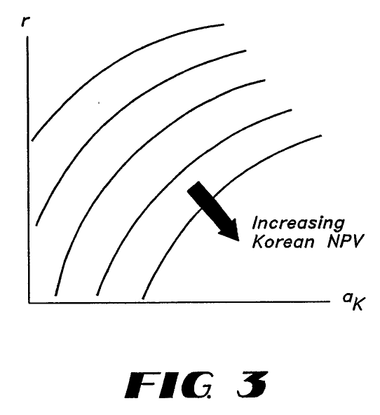

The schematic diagram FIG. 3 below maps the royalty rate (r) versus the Korean partner's equity share a_{K}. The simulations produce entire families of isoNPV curves, with NPV increasing along a certain vector, as illustrated.

However, for the sake of visual clarity in FIGS. 4-10, only one curve for each negotiating company, going through the baseline values for the variables, will be shown, with the direction of NPV increase for each firm indicated by a vector.

$${NPV}_{K} = - \frac{{a}_{K} V}{1 + {d}_{K}} + {a}_{K} ( 1 - {t}_{K} ) \{ ( 1 - r ) S - ( \frac{1}{y} + {i}_{K} ) L - ( 1 + m ) M - E \} {D}_{Ky}$$

$${NPV}_{A} = \frac{L ( 1 - {t}_{A} ) - {a}_{A} V}{1 + {d}_{A}} + [ ( 1 - {t}_{A} ) ( rS + mM ) + {a}_{A} ( 1 - {t}_{K} ) \{ ( 1 - r ) S - ( \frac{1}{y} + {i}_{K} ) L - ( 1 + m ) M - E \} ] {D}_{Ay}$$

$$where {D}_{Ky} = {\sum }_{p = 1}^{y} \frac{1}{{( 1 + {d}_{K} )}^{p}} and {D}_{Ay} = {\sum }_{p = 1}^{y} \frac{1}{{( 1 + {d}_{A} )}^{p}} ( {d}_{K} ; {d}_{A} \neq 0 )$$

The first order partial derivatives of these NPV curves will indicate the general direction of NPV increase for each family of curves. The derivatives have the following signs.

$$\frac{\partial {NPV}_{K}}{\partial {a}_{K}} = - \frac{V}{1 + {d}_{K}} + ( 1 - {t}_{K} ) {D}_{Ky} \{ ( 1 - r ) S - ( \frac{1}{y} + {i}_{K} ) L - ( 1 + m ) M - E \} > 0$$

$$\frac{\partial {NPV}_{K}}{\partial r} = - {a}_{K} ( 1 - {t}_{K} ) {D}_{Ky} S < 0$$

$$\frac{\partial {NPV}_{K}}{\partial L} = - {a}_{K} ( 1 - {t}_{K} ) {D}_{Ky} ( \frac{1}{y} + {i}_{K} ) < 0$$

$$\frac{\partial {NPV}_{K}}{\partial y} = {a}_{K} ( 1 - {t}_{K} ) [ \frac{L}{{y}^{2}} {D}_{Ky} + \{ ( 1 - r ) S - ( \frac{1}{y} + {i}_{K} ) L - ( 1 + m ) M - E \} \frac{ln ( 1 + {d}_{K} )}{{{d}_{K} ( 1 + {d}_{K} )}^{y}} ] > 0 \\ \frac{\partial {NPV}_{K}}{\partial m} = - {a}_{K} ( 1 - {t}_{K} ) {D}_{Ky} M < 0 \\ \frac{\partial {NPV}_{A}}{\partial {a}_{K}} = \frac{V}{1 + {d}_{A}} - ( 1 - {t}_{K} ) {D}_{Ay} \{ ( 1 - r ) S - ( \frac{1}{y} + {i}_{K} ) L - ( 1 + m ) M - E \} < 0 \\ \frac{\partial {NPV}_{A}}{\partial r} = \{ ( 1 - {t}_{A} ) - {a}_{A} ( 1 - {t}_{K} ) \} {D}_{Ay} S > 0 \\ \frac{\partial {NPV}_{A}}{\partial L} = \frac{1 - {t}_{A}}{1 + {d}_{A}} - {a}_{A} ( 1 - {t}_{K} ) ( \frac{1}{y} + {i}_{K} ) {D}_{Ay} > 0 \\ \frac{\partial {NPV}_{A}}{\partial y} = {a}_{A} ( 1 - {t}_{K} ) \\ {D}_{Ay} \frac{L}{{y}^{2}} + [ ( 1 - {t}_{A} ) ( rS + mM ) + {a}_{A} ( 1 - {t}_{K} ) \{ ( 1 - r ) S - ( \frac{1}{y} + {i}_{K} ) L - ( 1 + m ) M - E \} ] \{ \frac{ln ( 1 + {d}_{A} )}{{{d}_{A} ( 1 + {d}_{A} )}^{y}} \} > 0 \\ \frac{\partial {NPV}_{A}}{\partial m} = \{ ( 1 - {t}_{A} ) - {a}_{A} ( 1 - {t}_{K} ) \} {D}_{Ay} M > 0$$

Each isoNPV family of curves has a certain vector, or general direction of NPV increase determined by the signs of the first order partial derivatives. This is also shown in the FIGS. 4-10 below.

1. Tradeoff Between Equity and Royalty Rate (a_{K} vs. r) FIG. 4 shows isoNPV curves for the American and Korean side. To avoid visual clutter, each figure shows only one isoNPV curve for each negotiating party. Two variables are mapped at a time in order to facilitate illustration of the concepts in a two-dimensional graph. Multidimensional graphs are of course contemplated. However, each curve represents an entire family of isoNPV curves increasing in a certain direction, as shown by the arrows. The vector of increasing NPV for each party is depicted by algebraic expressions.

$$\frac{\partial {NPV}_{K}}{\partial {a}_{K}} > 0 and \frac{\partial {NPV}_{K}}{\partial r} < 0 ; while \frac{\partial {NPV}_{A}}{\partial {a}_{K}} < 0 and \frac{\partial {NPV}_{A}}{\partial r} > 0$$

as shown above. Moreover, we can show that for any given a_{K} (except for the one point of (a_{K}, r) (0.5, 0.05)), r|_{NPV}_{K}≠r|_{NPV}_{A} and that the slopes of the two curves are not the same, i.e.,

$$\frac{\partial r}{\partial {a}_{K}} {\vert}_{{NPV}_{K}} \neq \frac{\partial r}{\partial {a}_{K}} {\vert}_{{NPV}_{A}} where \frac{\partial r}{\partial {a}_{K}} {\vert}_{{NPV}_{K}} = - \frac{\partial {NPV}_{K} / {\partial }_{{a}_{K}}}{\partial {NPV}_{K} / \partial r} = - \frac{- \frac{V}{1 + {d}_{K}} + ( 1 - {t}_{K} ) {D}_{Ky} \{ ( 1 - r ) S - ( \frac{1}{y} + {i}_{K} ) L - ( 1 + m ) M - E \}}{- {a}_{K} ( 1 - {t}_{K} ) {D}_{Ky} S} > 0$$

$$\frac{\partial r}{\partial {a}_{K}} {\vert}_{{NPV}_{A}} = - \frac{\partial {NPV}_{A} / {\partial }_{{a}_{K}}}{\partial {NPV}_{A} / \partial r} = - \frac{\frac{V}{1 + {d}_{A}} - ( 1 - {t}_{K} ) {D}_{Ay} \{ ( 1 - r ) S - ( \frac{1}{y} + {i}_{K} ) L - ( 1 + m ) M - E \}}{\{ ( 1 + {t}_{K} ) {a}_{K} + {t}_{K} - {t}_{A} \} {D}_{Ay} S} > 0$$

The family of isoNPV curves for the two negotiating sides exhibit opposite growth vectors, as we see in FIG. 1. Desires for higher NPV or profit of each partner, move in opposite directions.

Negotiation Dynamics

An interesting negotiation dynamic is thus presented. For the zone in between the two isoprofit curves in FIG. 4 is a “zone of mutual benefit”, with NPVs for both parties increasing there. That is to say, it is a joint-profit-maximizing zone. Giving the Koreans a higher equity share in the alliance, and the Americans (as knowledge suppliers) a higher royalty, leaves both with higher profit, provided this movement is within the zone.

However, moving to such higher-joint-profit zones, may have other non-financial ramifications for both parties which may not necessarily be beneficial to both parties. A secondary objective of this method is to show that financial and non-financial objectives (relating to strategy, control, risk and tax) may not always be congruent. For one thing, the a_{K} vs. r map the “zone of mutual benefit” can be very narrow. Second, since a_{K}=1−a_{A}, the American partner may not wish to lose control, or veto power on the board of directors (especially with a_{A}<0.50) by having their equity reduced below a certain level, even though it means slightly higher profit potential. Of course, the correlation between managerial control in alliances and ownership is very imperfect. Additionally, a partner's equity share is not the only means of control. For example, if the Americans supply critical materials on which the alliance depends, for which substitutes cannot be easily obtained, then the American influence can be strong despite a minority equity position, as demonstrated in studies such as Yan and Gray, 1994; Killing, 1983; and Lecraw 1984. Third, increasing the royalty rate, in what is after all a related party transaction, may attract the adverse attention of the tax authorities in many. Fourth, in conditions of lack of trust, and difficulty by the Americans in verifying royalty calculations, the above tradeoff involving higher royalties for a lower equity share, may not appeal to the American side. On the other hand, in conditions of environmental and political uncertainty, the above tradeoff would indeed be preferred by the Americans, since equivalent or higher NPV would be achieved with royalties which carry less risk than returns on equity. Note that in our simulation we discounted the royalty and dividend stream at equal rates, but one could argue that, royalties being axiomatically less volatile than dividends, the former should be discounted at a lower rate.

Thus we see that (a) the financial profit-increasing negotiating motive is often at odds with other non-financial considerations of a strategic, management control, risk, future partner behavior, and regulatory nature, and that (b) even for the same side (e.g. the Americans or knowledge supplier to the alliance firm) there can sometimes be contrary preferences, based on different considerations. This will be illustrated for all the tradeoffs. This is why alliance negotiations are complex and difficult.

Incidentally, since a_{A}=1−a_{K}, the graph of a_{A} vs. r is simply the mirror image of FIG. 1, with identical conclusions for the American and Korean positions, and is therefore not shown.

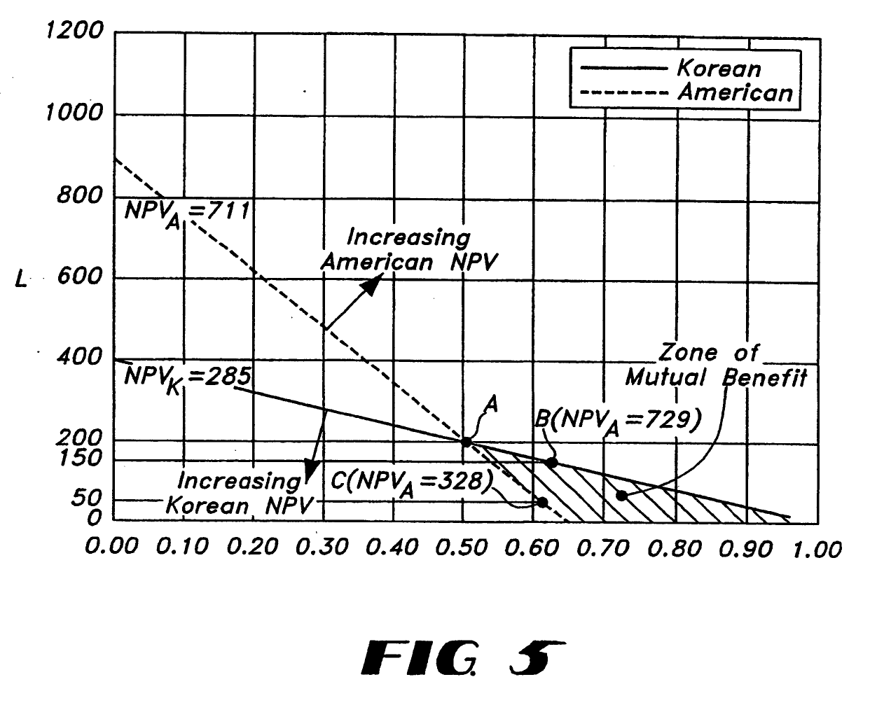

2. Tradeoff Between Royalty and Lumpsum (r vs. L) FIG. 5 shows the constant NPV lines for the American and Korean partners for the royalty versus lumpsum tradeoff—each representing an entire family of isoNPV curves increasing in the direction shown by the arrows. The algebraic expressions are shown below.

$$\frac{\partial {NPV}_{K}}{\partial r} < 0 ; \frac{\partial {NPV}_{K}}{\partial L} < 0 whereas \frac{\partial {NPV}_{A}}{\partial r} > 0 ; \frac{\partial {NPV}_{A}}{\partial L} > 0.$$

Moreover, the relationship between r and L is linear, and

$$\frac{\partial L}{\partial r} {\vert}_{{NPV}_{K}} > \frac{\partial L}{\partial r} {\vert}_{{NPV}_{A}} where \frac{\partial L}{\partial r} {\vert}_{{NPV}_{K}} = - \frac{\partial {NPV}_{K} / {\partial }_{r}}{\partial {NPV}_{K} / \partial L} = - \frac{S}{\frac{1}{y} + {i}_{K}} < 0$$

$$\frac{\partial L}{\partial r} {\vert}_{{NPV}_{A}} = - \frac{\partial {NPV}_{A} / {\partial }_{r}}{\partial {NPV}_{A} / \partial L} = - \frac{\{ ( 1 - {t}_{A} ) - {a}_{A} ( 1 - {t}_{K} ) \} {D}_{Ay} S}{\frac{1 - {t}_{A}}{1 + {d}_{A}} - {a}_{A} ( 1 - {t}_{K} ) ( \frac{1}{y} + {i}_{K} ) {D}_{Ay}} < 0$$

The isoNPV lines for the two company negotiators move in opposite directions, as shown in FIG. 5. But, with different slopes, there is a “zone of mutual benefit” in the shaded triangular area, with greater r and lower L. For the Korean side, this is most welcome, since they stand to increase their NPV_{K} while lowering the breakeven point of the alliance enterprise as a whole. Fixed cost (of long-term debt service) is lowered with a lower L. Certainly, royalties as a variable cost increase under this tradeoff. However, these are paid out only in the event of sales success. Overall risk of the agreement for the alliance firm is reduced from the Korean perspective. Lastly, an important consideration for recipients of knowledge (the Koreans in this example): A higher royalty rate automatically ensures a higher degree of continued interest from a licensor who now has a vested interest in continued knowledge transfers to the alliance firm in Korea as licensee. By contrast, with a lumpsum, there is the fear that the knowledge supplier may “take their money and run” and shirk from helping the technology recipient in the future.

From the knowledge-supplier (American) perspective the tradeoff is equivocal. The slope of the NPV_{A} function is steeper, i.e. sensitive. Even if the Americans obtained a higher NPV_{A} in the zone of mutual benefit, would they be willing to give up the surety of the lumpsum, paid up front, on signing the agreement—for relatively less certain future royalties?

This is illustrated by comparing the points A, B and C in FIG. 4. For the same royalty rate, say r=0.06, there is a very large negotiating range, with lumpsums going from L=60 to L=160. This sets up various games such as,

The American Gambit: (Point A to Point B) Tell the Koreans they want 1 % point more royalty (r=0.06), in return for lowering L from 200 to 160. (All incremental gains would then go to the Americans).

The Korean Gambit: (Point A to Point C) Tell the Americans they are willing to grant 1% point higher royalty in return for a lumpsum of L=60. (All incremental gains would then go to the Koreans).

Between points B and C both parties show some incremental gain. They should therefore compromise somewhere in between B and C, at (r=0.06; 60<L<160).

From the point of view of maximizing joint profit in alliances, this simulation illustrates the common sub-optimality of a lumpsum provision, in general. Ultimately, for the knowledge supplier as recipient of the lumpsum, it boils down to a tradeoff between profit increase versus slightly higher risk—the risk of relying on future royalties (as opposed to the surety of an immediate, up-front revenue in the lumpsum).

3 & 4. Tradeoff Between Agreement Life and Royalty Rate or Equity (y vs. r or a_{K})

Algebraic expressions for the tradeoffs between agreement life on the one hand and royalty or equity share on the other, are shown below.

$$\frac{\partial {NPV}_{K}}{\partial y} > 0 and \frac{\partial {NPV}_{K}}{\partial r} < 0 while \frac{\partial {NPV}_{A}}{\partial y} > 0 and \frac{\partial {NPV}_{A}}{\partial r} > 0 and \frac{\partial r}{\partial y} {\vert}_{{NPV}_{K}} > 0 and \frac{\partial r}{\partial y} {\vert}_{{NPV}_{A}} < 0$$

$$where$$

$$\frac{\partial r}{\partial y} {\vert}_{{NPV}_{K}} = - \frac{\partial {NPV}_{K} / {\partial }_{y}}{\partial {NPV}_{K} / \partial r} = \frac{1}{{D}_{Ky} S} [ \frac{L}{{y}^{2}} {D}_{Ky} + \{ ( 1 - r ) S - ( \frac{1}{y} + {i}_{K} ) L - ( 1 + m ) M - E \} \frac{ln ( 1 + {d}_{K} )}{{{d}_{K} ( 1 + {d}_{K} )}^{y}} ] \frac{\partial r}{\partial y} {\vert}_{{NPV}_{A}} = - \frac{\partial {NPV}_{A} / \partial y}{\partial {NPV}_{A} / \partial r} = - \frac{\begin{matrix}{a}_{A} ( 1 - {t}_{K} ) {D}_{Ay} \frac{L}{{y}^{2}} + [ ( 1 - {t}_{A} ) ( rS + mM ) + {a}_{A} ( 1 - {t}_{K} ) \\ \{ ( 1 - r ) S - ( \frac{1}{y} + {i}_{K} ) L - ( 1 + m ) M - E \} ] \{ \frac{ln ( 1 + {d}_{A} )}{{{d}_{A} ( 1 + {d}_{A} )}^{y}}\end{matrix}}{\{ ( 1 - {t}_{A} ) - {a}_{A} ( 1 - {t}_{K} ) \} {D}_{Ay} S}$$

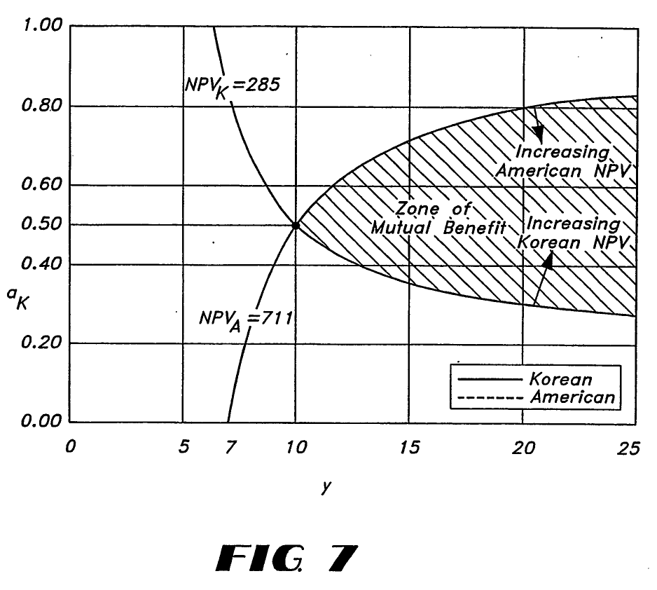

Similarly, in the y vs. a_{K} graph in FIG. 7,

$$\frac{\partial {NPV}_{K}}{\partial y} > 0 and \frac{\partial {NPV}_{K}}{\partial {a}_{K}} > 0 while \frac{\partial {NPV}_{A}}{\partial y} > 0 and \frac{\partial {NPV}_{A}}{\partial {a}_{K}} < 0 and \frac{\partial {a}_{K}}{\partial y} {\vert}_{{NPV}_{K}} < 0 and \frac{\partial {a}_{K}}{\partial y} {\vert}_{{NPV}_{A}} > 0$$

$$where \frac{\partial {a}_{K}}{\partial y} {\vert}_{{NPV}_{K}} = - \frac{\partial {NPV}_{K} / {\partial }_{y}}{\partial {NPV}_{K} / \partial {a}_{K}} = - \frac{{a}_{K} ( 1 - {t}_{K} ) [ \frac{L}{{y}^{2}} {D}_{Ky} + \{ ( 1 - r ) S - ( \frac{1}{y} + {i}_{K} ) L - ( 1 + m ) M - E \} \frac{ln ( 1 + {d}_{K} )}{{{d}_{K} ( 1 + {d}_{K} )}^{y}} ]}{- \frac{V}{1 + {d}_{K}} + ( 1 - {t}_{K} ) {D}_{Ky} \{ ( 1 - r ) S - ( \frac{1}{y} + {i}_{K} ) L - ( 1 + m ) M - E \}} \frac{\partial {a}_{K}}{\partial y} {\vert}_{{NPV}_{K}} = - \frac{\partial {NPV}_{A} / {\partial }_{y}}{\partial {NPV}_{A} / \partial {a}_{K}} = - \frac{\begin{matrix}{a}_{A} ( 1 - {t}_{K} ) {D}_{Ay} \frac{L}{{y}^{2}} + [ ( 1 - {t}_{A} ) ( rS + mM ) + {a}_{A} ( 1 - {t}_{K} ) \{ ( 1 - r ) \\ S - ( \frac{1}{y} + {i}_{K} ) L - ( 1 + m ) M - E \} ] \{ \frac{ln ( 1 + {d}_{A} )}{{{d}_{A} ( 1 + {d}_{A} )}^{y}} \}\end{matrix}}{\frac{V}{1 + {d}_{A}} - ( 1 - {t}_{K} ) {D}_{Ay} \{ ( 1 - r ) S - ( \frac{1}{y} + {i}_{K} ) L - ( 1 + m ) M - E \}}$$

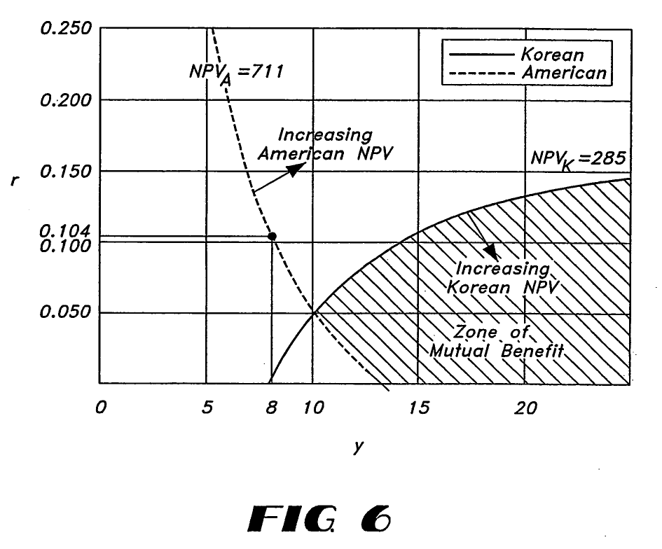

Every negotiator should plot graphs similar to FIGS. 6 and 7, for significant strategic deductions about the duration of the agreement. Ceteris paribus, a longer agreement increases the projected present value of both parties; but this is an obvious and foregone conclusion with no negotiation significance. The more important significance of FIGS. 6 and 7 lies in the asymptotes of each curve. The entire family of Korean curves quickly become flat with increasing y, suggesting an asymptotic limit to the ability of the alliance company to pay higher royalties without detriment to the Korean partner's NPV_{K}. In this simulation example the limit is not restrictive, but in other cases it can be a concern.

Even more significantly, the risks of curtailment of the agreement to less than its expected life—a not uncommon occurrence in alliances—is of concern. A great many alliances do not last as long as anticipated at their creation. The American (knowledge-supplier) curves in both FIGS. 6 and 7 are steep, for y<10 years, indicating a significant sensitivity to the curtailment of the agreement (whether ex ante, or especially, ex post). For instance, in FIG. 6 (agreement life vs. royalty rate) a curtailment of only two years (y=8 instead of y=10) would require the royalty rate to more than double, from r=0.05 to r=0.104, just for the Americans to stay even—and this despite the fact that cash flows in years 9 and 10 are heavily discounted. But a doubling of the royalty rate would be totally unacceptable to the Koreans, so that they are not likely to accept such a tradeoff during negotiations. Ex post then, the normal arrangement leaves the Americans vulnerable and dependent on an alliance life continuing beyond the tenth year. Curtailment of agreement life is an especially acute issue in the event of idiosyncratic, or unrecoverable alliance-specific investments.

FIG. 7 (equity percentage versus agreement life) reveals natural asymptotic limits to both y and a_{K} (or a_{A}). No matter how hard the American negotiator tries to push the Korean equity share down, an agreement of less than seven years is dangerous, and infeasible in terms of meeting expected NPV targets. That conclusion should raise a host of questions in the Americans' minds about the long term reliability of the Korean partner, and other environmental or regulatory factors that affect the longevity of the arrangement. For instance, there are still countries such as Korea, whose governments try to limit the life of technology agreements. If the government time limit falls below the critical zone, figures such as FIGS. 6 and 7 can reveal potential problems, in advance—thus proving their utility as a negotiating tool.

Tradeoff Between Intra-Firm Trade Markup and Royalty Rate (m vs. r)

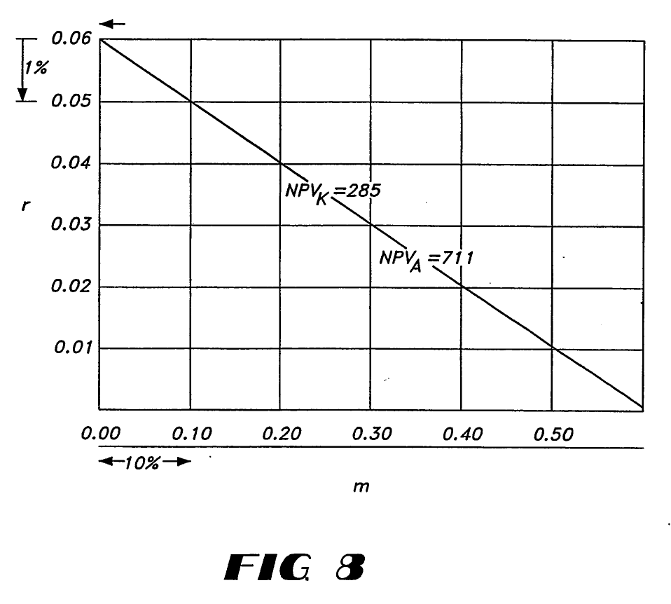

The relationship between m and r is linear in FIG. 8, since both are linearly related to sales value. The two isoNPV curves have the same slope, i.e.,

$$\frac{\partial r}{\partial m} {\vert}_{{NPV}_{K}} = \frac{\partial r}{\partial m} {\vert}_{{NPV}_{A}} = - \frac{M}{S} .$$

In the simulation, a 10% point change in the markup is equivalent to a 1% point change in the royalty rate, typifying a fairly common situation. But, while r and (0.1 m) are equivalent or neutral in numerical impact on profit or NPVs, they differ significantly in implications for long term behavior of the allies and for strategy. Whereas r is part of the agreement, m is not, and more difficult to monitor. The partner supplying the component or input faces the temptation to cheat, by increasing the markup “m”. In this case, the knowledge recipient (Korean) partner worries about monitoring the honesty (or opportunism) of the Americans who will supply the raw material, obtained from a separate, far away nation, over ten or more years. The Americans are less worried about ‘r’, since they can try to monitor royalty calculations from the closer vantage point of an equity partner. (This argument would not apply to a licensing-only alliance).

6. Tradeoff Between Agreement Life and Lumpsum (v vs. L)

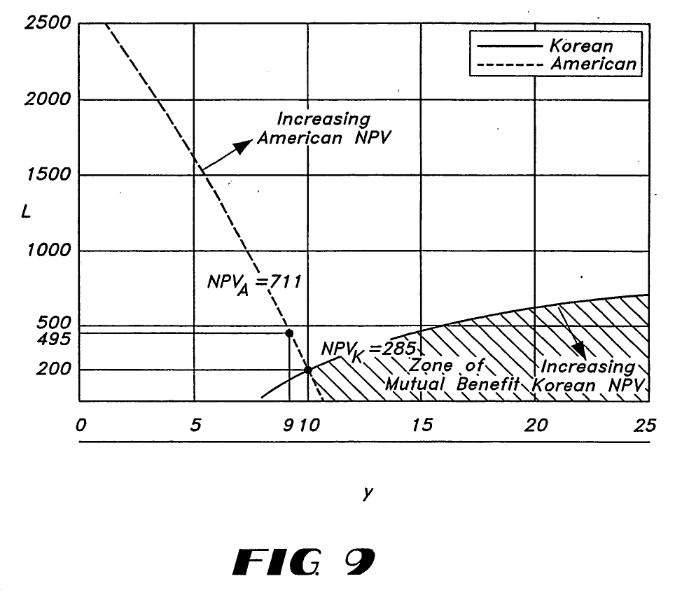

FIG. 9 shows isoNPV curves for the American and Korean side. FIG. 6 reiterates the sub-optimality of large lumpsums and the sensitivity of the agreement life. NPV_{A} is a steep function, so that a huge increase in lumpsum amount L, from 200 to 495 (see points P and Q) is equivalent to reduction of agreement life by only the terminal tenth year. In general, lumpsums are problematic and costly. Since they are often financed by a joint venture alliance company out of debt, a higher L lowers profits (by increasing the debt service burden) for both partners. Overall, it is not a satisfactory tradeoff. The value of this method is that it reveals such financial and strategy issues to negotiators.

7. Lowering the Lumpsum

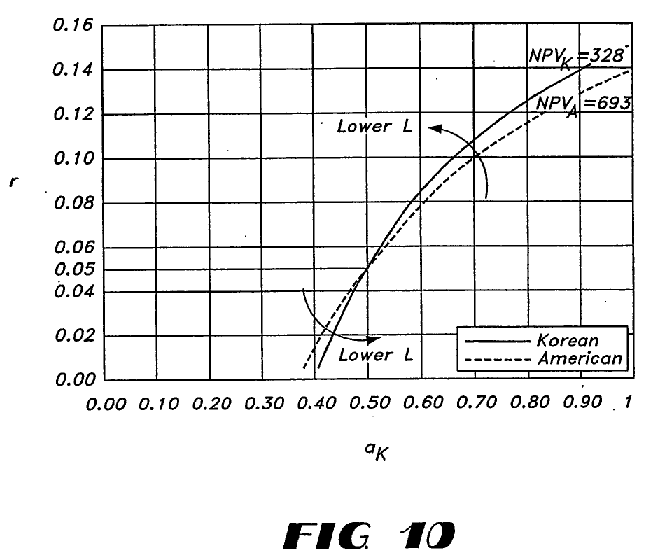

The advantages of reducing lumpsums is further illustrated by FIG. 10, which is a redrawing of FIG. 4 (a_{K} vs. r). However, this time the simulation is asked to specify a lumpsum of L=100 only, instead of L=200, which is half its former (baseline) value. With all other variables held constant, a lower L

(i) Rotates the curves for both NPV_{A} and NPV_{K} counterclockwise with respect to the baseline pivot

(ii) The knowledge recipients (Koreans) gain substantially, since NPV_{K} is now 328 (instead of 285)

(iii) But NPV_{A} for the knowledge supplier, at 693, is only slightly lower than the FIG. 4 value of 711. That is to say, a big 50 percent reduction in lumpsum reduces the American NPV by a mere 2.5 percent (which can be made up by other small concessions on other variables) while increasing the Korean partner's NPV by 15 percent.

This shows that both parties can gain, and increase their joint profit, by reducing the lumpsum payment. But this is only a financial consideration. Non-financial considerations may not be congruent with financial considerations. Despite increased or neutral profits from a lower lumpsum, the Americans (as knowledge providers to the alliance) may be reluctant to do so, for reasons of caution, certainty, and immediacy. A lumpsum is contractually specified, and payable at the inception of a project Royalties, linked to sales are less secure, and are out in the future. Dividend returns on equity investment occur even later, and are the least certain of all.

Behavioral Implications of Compensation Alternatives

Table 7 summarizes the behavioral implications of each party's negotiators' expectations of shirking, opportunism, monitoring and other risks.

The receiver of expertise (the Koreans in our example) wish to ensure the continuing help of the knowledge suppliers (Americans) in later years, and fear that they may shirk from their duty to help the alliance. This is especially true when a expertise supplier's returns are front-end loaded, for example with a high lumpsum. This strategic caveat should lead the Koreans to offer a lower initial lumpsum, in return for higher royalties and/or equity stake. This also has the virtue of reducing fixed costs of the alliance. By contrast, the increased variable cost of a higher royalty rate is paid only out of commercial success.

TABLE 7
Behavioral and Negotiation Implications of the Negotiation Variables

| Strategy Concept | Caveat or Concern | Negotiating Response |
|---|---|---|
| SHIRKING | Receiver of Expertise wishes to | Reduce L; Offer higher r and higher |
| | ensure continuing flows of | a_{A} instead. (Pay supplier of expertise |
| | knowledge and assistance in the | out of business success; convert fixed |
| | future (Korean concern) | cost to variable cost) |
| OPPORTUNISM | Curtailment of Agreement Life | Ask for a_{A} > 0.50; write curtailment |
| | (American concern) | penalties in agreement; increase L |
| | Unilateral increase in margin on | Keep option for alternative supply |
| | trade (Korean concern) | source |
| MONITORING | Understatement of Royalty Basis | Managerial presence in alliance; |
| | (American concern) | provision for external audit |
| | Overvaluation of traded good | External audit; commercial |
| | (Korean concern) | intelligence |
| OTHER RISKS | Volatility of political and commercial | Higher r; lower a_{A} |
| | environment (American concern) | |
| | Cyclical industry | L better than r; r better than a_{A} |
| | (American concern) | |
| | Poor performance of enterprise | Offer higher a_{A} in return for lower L |
| | saddled with high L and high r | and lower r |
| | (Korean worry) | |
| | Losing control over management and | a_{A} > 0.50; write veto clauses into |
| | quality (American concern) | agreement; keep alliance dependent |
| | | on supply of materials/components |
| | Creating a future competitor | Withholding or reducing flow of |
| | (American concern) | knowledge; Try to write non- |
| | | compete clauses in agreement |

In the above situation, joint profit maximization and strategic caveat may be congruent. However, the two are not congruent with regard to the American side's fear of a curtailed agreement life. Simulation results in FIGS. 6 and 7 illustrated the sensitivity of the American NPV to a shorter agreement. This concern would have them demanding a higher lumpsum, which is suboptimal. Alternatively, curtailment penalties may be demanded as an agreement provision, but the Koreans would likely balk at that demand. The Koreans, on their part, are concerned about opportunism from the American side in overpricing the raw material or components supplied to the alliance, a frequent source of conflict in. The hope that they will be moderate on the transfer price, is often a misguided idea. This is because any increment to the unit transfer price Δm, is far higher than the gain in the Americans' profit share. That is to say, ΔmM>>a_{A} (1−t_{K})ΔmM. Besides, the transfer price profit is earned in the US, where it is also not subject to Korean taxes. The Koreans can only hope for self-restraint and moderation from their American partners. Of course, keeping the option of an alternative supply source always helps.

While developing trust, both sides will however wish to monitor each other. The Americans, as knowledge suppliers and licensors, are concerned about the accounting accuracy of royalty basis calculations. For example, even the definition of “Sales” on which royalty is paid, is far from simple. Is “sales value” computed ex-factory, FOB warehouse, or wholesale? Does it include or exclude excise and value-added taxes? Does it exclude returns, rejects and remanufactured items? In a multi-product operation, what products or models fall within or without the definition of the licensed technology ? A more tightly drafted alliance agreement, including external audit provisions is one response. But daily managerial participation in the alliance, by means of a significant equity stake, is better. In volatile economic and political environments the tradeoff between royalty rate and equity share may not be viewed as a neutral movement along an isoprofit curve, and can be biased by risk-averse parties in favor of royalties which are less subject to volatility of the alliance sales (compared to volatile profits). In general, the greater the perception of environmental risk and volatility by the knowledge-supplying partner about the host nation of the alliance, the more they will be biased towards lumpsums and royalties compared to an equity stake. But this can be sub-optimal for the joint profits of the alliance, and for the other partner.

In general, an international knowledge-supplying firm is properly concerned about losing control over quality, and about the threat that their transfer of expertise will create a future competitor. Demanding a majority equity share may not always do the trick or be satisfactory, since the other partner may balk, and since tradeoffs may involve giving up too much of the relatively secure royalties and lumpsums. Moreover, there is only a very loose correlation between equity ownership and control. The knowledge-supplying firm may try to augment their leverage through other means, such as creating a dependency on a critical input that they supply, writing non-compete clauses in the agreement (these may be of dubious legality and enforceability) or withholding and reducing the flow of knowledge to the alliance. But such means are sometimes illegal, increase the potential for discord, and may be detrimental to the performance of the alliance from which the knowledge provider seeks to draw their future profits.

It is important to reiterate the overall conclusion: That neither the financial calculations, nor indeed the individual strategic considerations, point in a congruent direction for each negotiating side. Table 7 reveals contradictory recommendations with respect to L, r and a_{A}, and these, in turn may lead away from the “Zones of Mutual Benefit” in the financial calculation. For instance, on shirking, opportunism, and monitoring considerations, a higher a_{A} or American equity was recommended However, in a volatile political and commercial environment, the Americans may judge the risk as too high for substantial equity investment, despite other advantages. The most risk-averse position for the expertise supplier (Americans) to take would be to demand a very high lumpsum. But this, as we saw, is extremely inefficient financially, and strategically. More pertinently, weighting cash flows too much towards the front end has often resulted in the project becoming saddled with excessive fixed costs, or even unfeasible.

Why Alliance Negotiations are Complex

Such internal contradictions between the strategic considerations themselves, and between the strategic and financial considerations, show why alliances are such complex creations. And yet, the economic value that such company combinations create, and the knowledge they transfer across national borders, make alliances indispensable, and more than justify their often ephemeral nature. The method presented, the caveats indicated for non-financial variables, and the behavioral responses to each, will however help companies to craft better and longer-lasting alliances.

What is claimed is:

1. A method of conducting alliance negotiations comprising the step of:
providing a benefit/cost/and market revenue framework which enables one or more potential allies to calculate a target monetary value that may be captured by one or more of said potential allies over the life of a potential alliance.

2. The method of claim 1 further comprising the step of:
using negotiation variables comprising different compensation types as well as non-financial variables, to generate potential profit target scenarios as a basis for negotiating.

3. The method of claim 2 further comprising the step of:
evaluating one or more tradeoffs between said various compensation types to serve as potential negotiation proposals to a potential ally.

4. The method of claim 1, further comprising generating bargaining ranges for each potential ally.

5. The method of claim 1, further comprising arriving at estimates for the total present value of compensation and costs that could accrue to each potential ally.

6. The method of claim 2, further comprising generating isoprofit curves based on at least two different compensation types.

7. The method of claim 2, wherein said potential profit target scenarios are represented by the same or different isoprofit curves generated, one for each potential ally.

8. The method of claim 3, further comprising the steps of mapping at least one pair of negotiation variables and assessing the impact of said combination or combinations thereof on the potential profit targets of each potential ally.

9. The method of claim 3, further comprising the step of comparing negotiating variables of a potential ally against said profit scenarios.

10. The method of claim 3, further comprising selecting one or more tradeoffs to serve as a potential proposal to an ally.

11. The method of claim 10, further comprising the step of identifying a tradeoff zone of compensation beneficial to at least two potential allies.

12. The method of claim 10, wherein said tradeoffs are non-linear and non-zero sum tradeoffs between said compensation types.

13. The method of claim 3, wherein the steps of claim 2 and 3 are iterative.

14. The method of claim 2, wherein said negotiating variables comprise financial and non-financial variables.

15. The method of claim 2, wherein said negotiating variables are selected from the group consisting of equity shares, royalties, lump sum fees, intra-ally transfer-price mark-ups, duration of the alliance, and combinations thereof.

16. The method of claim 2, wherein said negotiating variables comprise an evaluation of the risks associated with potential failure to provide continued cooperation, potential failure to provide continued exchange of information or exchange of resources, increases in margins on trade, proper reporting or calculation of royalties; concerns regarding unfavorable political and commercial environments and combinations thereof.

17. The method of claim 2, wherein said profit scenarios are generated by a computer
program based on said targeted monetary value.

18. The method of claim 17, wherein the profit scenarios for tradeoffs between equity
and royalty compensations are shown to be at least two different curves as plotted in accordance with the following algebraic expressions:
$$\frac{\partial {NPV}_{K}}{\partial {a}_{K}} > 0 and \frac{\partial {NPV}_{K}}{\partial r} < 0 ; while \frac{\partial {NPV}_{A}}{\partial {a}_{K}} < 0 and \frac{\partial {NPV}_{A}}{\partial r} > 0$$
as shown above. Moreover, we can show that for any given a_{K} (except for the one point of (a_{K}, r) (0.5, 0.05)), r|_{NPV}_{K}≠r|_{NPV}_{A} and that the slopes of the two curves are not the same, i.e.,
$$\frac{\partial r}{\partial {a}_{K}} {\vert}_{{NPV}_{K}} \neq \frac{\partial r}{\partial {a}_{K}} {\vert}_{{NPV}_{A}} where$$
$$\begin{matrix}\frac{\partial r}{\partial {a}_{K}} {\vert}_{{NPV}_{K}} = - \frac{\frac{\partial {NPV}_{K}}{\partial {a}_{K}}}{\frac{\partial {NPV}_{K}}{\partial r}} \\ = - \frac{\begin{matrix}- \frac{V}{1 + {d}_{K}} + ( 1 - {t}_{K} ) {D}_{Ky} \\ \{ ( 1 - r ) S - ( \frac{1}{y} + {i}_{K} ) L - ( 1 + m ) M - E \}\end{matrix}}{- {a}_{K} ( 1 - {t}_{K} ) {D}_{Ky} S} > 0\end{matrix}$$
$$\begin{matrix}\frac{\partial r}{\partial {a}_{K}} {\vert}_{{NPV}_{A}} = - \frac{\frac{\partial {NPV}_{A}}{\partial {a}_{K}}}{\frac{\partial {NPV}_{A}}{\partial r}} \\ = - \frac{\begin{matrix}\frac{V}{( 1 + {d}_{A} )} - ( 1 - {t}_{K} ) {D}_{Ay} \\ \{ ( 1 - r ) S - ( \frac{1}{y} + {i}_{K} ) L - ( 1 + m ) M - E \}\end{matrix}}{\{ ( 1 + {t}_{K} ) {a}_{K} + {t}_{K} - {t}_{A} \} {D}_{Ay} S} > 0\end{matrix}$$

19. The method of claim 17, wherein the profit scenarios for tradeoffs between royalty and lumpsum compensations are shown to be at least two different curves as plotted in accordance with the following algebraic expressions:
$$\frac{\partial {NPV}_{K}}{\partial r} < 0 ; \frac{\partial {NPV}_{K}}{\partial L} < 0$$
$$whereas$$
$$\frac{\partial {NPV}_{A}}{\partial r} > 0 ; \frac{\partial {NPV}_{A}}{\partial L} > 0.$$
Moreover, the relationship between r and L is linear, and
$$\frac{\partial L}{\partial r} {\vert}_{{NPV}_{K}} > \frac{\partial L}{\partial r} {\vert}_{{NPV}_{A}} where$$
$$\frac{\partial L}{\partial r} {\vert}_{{NPV}_{K}} = - \frac{\frac{\partial {NPV}_{K}}{\partial r}}{\frac{\partial {NPV}_{K}}{\partial L}} = - \frac{S}{\frac{1}{y} + {i}_{K}} < 0$$
$$\begin{matrix}\frac{\partial L}{\partial r} {\vert}_{{NPV}_{A}} = - \frac{\frac{\partial {NPV}_{A}}{\partial r}}{\frac{\partial {NPV}_{A}}{\partial L}} \\ = - \frac{\{ ( 1 - {t}_{A} ) - {a}_{A} ( 1 - {t}_{K} ) \} {D}_{Ay} S}{\frac{1 - {t}_{A}}{1 + {d}_{A}} - {a}_{A} ( 1 - {t}_{K} ) ( \frac{1}{y} + {i}_{K} ) {D}_{Ay}} < 0\end{matrix}$$

20. The method of claim 17, wherein the profit scenarios for tradeoffs between agreement life on the one hand and royalty or equity share on the other hand are shown to be at least two different curves as plotted in accordance with the following algebraic expressions:
$$\frac{\partial {NPV}_{K}}{\partial y} > 0 and \frac{\partial {NPV}_{K}}{\partial r} < 0 while$$
$$\frac{\partial {NPV}_{A}}{\partial y} > 0 and \frac{\partial {NPV}_{A}}{\partial r} > 0 and$$
$$\frac{\partial r}{\partial y} {\vert}_{{NPV}_{K}} > 0 and \frac{\partial r}{\partial y} {\vert}_{{NPV}_{A}} < 0 where$$
$$\begin{matrix}\frac{\partial r}{\partial y} {\vert}_{{NPV}_{K}} = - \frac{\frac{\partial {NPV}_{K}}{\partial y}}{\frac{\partial {NPV}_{K}}{\partial r}} \\ = \frac{1}{{D}_{Ky} S} [ \frac{L}{{y}^{2}} {D}_{Ky} + \{ ( 1 - r ) S - ( \frac{1}{y} + {i}_{k} ) L - ( 1 + m ) M - E \} \\ \frac{ln ( 1 + {d}_{K} )}{{{d}_{K} ( 1 + {d}_{K} )}^{y}} ]\end{matrix}$$
$$\begin{matrix}\frac{\partial r}{\partial y} {\vert}_{{NPV}_{A}} = - \frac{\frac{\partial {NPV}_{A}}{\partial y}}{\frac{\partial {NPV}_{A}}{\partial r}} \\ = - \frac{\begin{matrix}{a}_{A} ( 1 - {t}_{K} ) {D}_{Ay} \frac{L}{{y}^{2}} + \\ [ ( 1 - {t}_{A} ) ( rS + mM ) + {a}_{A} ( 1 - {t}_{K} ) \\ \{ ( 1 - r ) S - ( \frac{1}{y} + {i}_{k} ) L - ( 1 + m ) M - E \} ] \{ \frac{ln ( 1 + {d}_{A} )}{{d}_{A} ( 1 + {d}_{A} )}\end{matrix}}{\{ ( 1 - {t}_{A} ) - {a}_{A} ( 1 - {t}_{K} ) \} {D}_{Ay} S}\end{matrix}$$
$$and$$
$$\frac{\partial {NPV}_{K}}{\partial y} > 0 and \frac{\partial {NPV}_{K}}{\partial {a}_{K}} > 0 while$$
$$\frac{\partial {NPV}_{A}}{\partial y} > 0 and \frac{\partial {NPV}_{A}}{\partial {a}_{K}} < 0 and$$
$$\frac{\partial {a}_{K}}{\partial y} {\vert}_{{NPV}_{K}} < 0 and \frac{\partial {a}_{K}}{\partial y} {\vert}_{{NPV}_{A}} > 0 where$$
$$\begin{matrix}\frac{\partial {a}_{K}}{\partial y} {\vert}_{{NPV}_{K}} = - \frac{\frac{\partial {NPV}_{K}}{\partial y}}{\frac{\partial {NPV}_{K}}{\partial {a}_{K}}} \\ = - \frac{\begin{matrix}{a}_{K} ( 1 - {t}_{K} ) [ \frac{L}{{y}^{2}} {D}_{Ky} + \{ ( 1 - r ) S - \\ ( \frac{1}{y} + {i}_{k} ) L - ( 1 + m ) M - E \} \frac{ln ( 1 + {d}_{K} )}{{{d}_{K} ( 1 + {d}_{K} )}^{y}} ]\end{matrix}}{\begin{matrix}- \frac{V}{1 + {d}_{K}} + ( 1 - {t}_{K} ) {D}_{Ky} \\ \{ ( 1 - r ) S - ( \frac{1}{y} + {i}_{K} ) L - ( 1 + m ) M - E \}\end{matrix}}\end{matrix}$$
$$\begin{matrix}\frac{\partial {a}_{K}}{\partial y} {\vert}_{{NPV}_{A}} = - \frac{\frac{\partial {NPV}_{A}}{\partial y}}{\frac{\partial {NPV}_{A}}{\partial {a}_{K}}} \\ = - \frac{\begin{matrix}{a}_{A} ( 1 - {t}_{K} ) {D}_{Ay} \frac{L}{{y}^{2}} + \\ [ ( 1 - {t}_{A} ) ( rS + mM ) + {a}_{A} ( 1 - {t}_{K} ) \{ ( 1 - r ) S - \\ ( \frac{1}{y} + {i}_{k} ) L - ( 1 + m ) M - E \} ] \{ \frac{ln ( 1 + {d}_{A} )}{{{d}_{A} ( 1 + {d}_{A} )}^{y}} \}\end{matrix}}{\begin{matrix}\frac{V}{1 + {d}_{A}} + ( 1 - {t}_{K} ) {D}_{Ay} \\ \{ ( 1 - r ) S - ( \frac{1}{y} + {i}_{K} ) L - ( 1 + m ) M - E \}\end{matrix}}\end{matrix}$$

21. The method of claim 17, wherein the profit scenarios for tradeoffs between intrafirm trading markup and royalty rate compensations are shown to be at least two different curves as plotted in accordance with the following algebraic expressions:
$$\frac{\partial r}{\partial m} {\vert}_{{NPV}_{K}} = \frac{\partial r}{\partial m} {\vert}_{{NPV}_{A}} = - \frac{M}{S}$$

22. A method for generating compensation structures in an alliance agreement, comprising the steps of:
a. generating one or more net present value (iso-profit) curves of a potential alliance entity for one or more potential allies based on non-zero sum tradeoffs between at least two compensation types; and
b. identifying the vector for increasing net present value for a particular ally.

23. The method of claim 22 further comprising identifying among said curves a zone of mutual compensation benefit to potential allies.

24. The method of claim 22, wherein generation of net present value curves is based on a target monetary value of said potential alliance.

25. The method of claim 22, wherein said net present value is calculated using a framework comprising an assembly of compensation, cost and revenue criteria for a potential alliance entity which enables potential allies to reach a target monetary value.

26. A system for generating a compensation structure in an alliance agreement comprising:
c. a financial framework comprising an assembly of compensation, cost and revenue criteria from which a target monetary value of a potential alliance entity can be calculated over the life of the potential alliance; and
d. a software program capable of manipulating data in conjunction with said financial framework.

27. The system of claim 26, wherein said manipulation uses different compensation types and non-financial variables to generate potential profit target scenarios.

28. The system of claim 26, wherein said manipulation uses different compensation types and non-financial variables to generate isoprofit curves.

29. The system of claim 28, wherein said isoprofit curves are generated for each potential ally.

30. The system of claim 29, wherein said isoprofit curves are the same or different for each potential ally.

31. The system of claim 26, wherein said financial framework is incorporated into said software program.

32. The system of claim 26, wherein said manipulation further comprises the steps of mapping at least one pair of negotiation variables and assessing the impact of said combination or combinations thereof on the potential profit targets of each potential ally.

33. The system of claim 32, wherein said manipulation further comprises evaluating one or more tradeoffs between said various compensation types.

34. The system of claim 26, wherein said system is accessible via a computer network.

35. The system of claim 26, wherein said system is accessible via the internet or intranet.

36. The system of claim 26, wherein said system is accessible via the worldwide web.

37. The system of claim 26, wherein said assembly of compensation, cost and revenue criteria are selected from the group consisting of royalty, loan amortization, imported components and combinations thereof.

38. The system of claim 26, further being incorporated into spreadsheet-containing software.

39. The system of claim 26, being capable of being used in conjunction with spreadsheet software.
